(19) United States
(12) Patent Application Publication
(10) Pub. No.: US 2025/0047698 A1
(43) Pub. Date: Feb. 6, 2025

(54) CYBERSECURITY AI-DRIVEN WORKFLOW MODIFICATION

(71) Applicant: Arctic Wolf Networks, Inc., Eden Prairie, MN (US)

(72) Inventors: Lance Rund, San Jose, CA (US); Matthew James Aguilar, Winter Garden, FL (US); Joshua McCarthy, Morgan Hill, CA (US); David B McKinley, Dartmouth, MA (US)

(21) Appl. No.: 18/787,380

(22) Filed: Jul. 29, 2024

Related U.S. Application Data
(60) Provisional application No. 63/530,726, filed on Aug. 4, 2023.

(51) Int. Cl. H04L 9/40

(52) U.S. Cl. CPC H04L 63/1425; H04L 63/20

(57) ABSTRACT

Disclosed embodiments provide techniques for cybersecurity AI-driven workflow modifications. A security orchestration, automation, and response (SOAR) platform used to manage a plurality of cybersecurity threat protection applications deployed across a cybersecurity network is accessed. A cybersecurity workflow is executed using the SOAR platform and one or more cybersecurity actions related to the workflow are captured and analyzed for workflow relevance. The cybersecurity actions can include steps taken by security operations center staff and automated cybersecurity threat protection applications. The analysis can be performed by machine learning, and can include evaluations of repeated cybersecurity incidents, operation regression exercises, and suggested remedial steps. The workflow analysis can include identifying recidivistic security operations responses. Based on the analysis, the cybersecurity workflow is updated to improve workflow quality. The updating can include reordering the workflow steps, automating responses of operations staff, or executing actions recommended by separate AI cybersecurity systems.

### INCORPORATION BY REFERENCE

This application claims the benefit of priority of U.S. Provisional Patent Application No. 63/530,726, filed Aug. 4, 2023, the entire contents of which are incorporated herein by reference.

### FIELD OF ART

This application relates generally to cybersecurity management and more particularly to cybersecurity AI-driven workflow modification.

### BACKGROUND

Computer and network security has been an issue of concern from the beginning of their use in the 1900s. Like other technologies, competition among inventors, manufacturers, merchants, and in some cases governments has caused some to resort to espionage, theft, and even sabotage to keep ahead of others. As the value of digital systems and the data they store has grown, criminals have targeted them as well. In the early days of computers, security was relatively simple. Computers were large, sometimes filling entire rooms. They had specialized power and environmental requirements. Programming and operating a computer required direct access. At first, a computer could only execute one program at a time and required a specialized operator to load the program, execute it, and collate the results. Computer use was limited to those with specialized knowledge. Someone wanting to do harm to the computer itself or use the computer for illegitimate or illegal purposes needed physical access, as well as the ability to program and operate the computer. Security was focused on guarding the computer components and the environment required to run them.

As computer systems became more advanced, the ability to run programs more quickly and easily grew. Programs could be input using cards, tapes, and magnetic media which could be fed into the computers more quickly and reliably. CPUs, memory, and storage grew in capacity and soon led to the development of time sharing and a network of access points. Groups of users could work on a computer at the same time as the operating system moved from one user to the next in turn, executing their programs, storage requests, and so on. Users could type in commands and programs using keyboards. Eventually, green or amber text displays replaced stacks of paper, allowing the users to see what they typed as well as to view the responses from the computer system. Computer security became more complicated as user access points or terminals spread out across buildings. Physical wiring was necessary to access the computer, thus security was confined primarily to protecting the computer system components and the physical environment of the computer, and controlling access to the user terminals. Operating systems added usernames and passwords to ensure that those using the computer were authorized to do so. As the number of computer users increased, and the amount of specialized knowledge required to interact with computer systems decreased, more attention was paid to ensuring that the computer users were performing their duties correctly and appropriately. Security applications were created to control which users had access to specific levels of the computer system, and specialists in managing security began to appear.

More recently, easy access to the internet, personal computers, and wireless networks has expanded the need for security exponentially. Users with no background in computer science or even a basic understanding of computer systems now have access to huge amounts of data and processing power. Cell phones, tablets, pads, and home game platforms can be used to access multiple computers simultaneously, represented by a simple web server platform. Users from across the globe can access systems anonymously or nearly so. As computing power and access has grown, cybercrime has grown along with it. Financial systems can be compromised; individual users, families, and small business can be exploited; infrastructure systems can be wrecked; and public and private information stolen. As the number and types of malicious and accidental security breaches have grown, so our need for cybersecurity has mushroomed. As our reliance on computer systems of all types increases, businesses, governments, and individual users will continue to face computer security challenges for many years to come.

### SUMMARY

Organizations of all types and sizes are dependent on continuous and reliable computing infrastructure, applications, and networks in order to function. Individuals and family groups are similarly dependent on cell phones, tablets, pads, and other digital devices to communicate, work, study, access services, shop, and play. Securing these devices and networks, and the data they rely on, requires effective detection, management, and mitigation of cybersecurity threats of all types. Individual users and organizations are increasingly aware of many diverse cybersecurity threats that are launched against them. Public and private organizations and businesses actively configure, implement, and deploy state-of-the art cybersecurity hardware and software to secure their information technology (IT) infrastructure against the threats. Private individuals do the same, with varying degrees of success. While preventive measures, such as installing updates to application and operating systems software, deactivating former users, requiring security checkups, and implementing other housekeeping activities, are common to successful IT operations, these measures alone are inadequate to provide comprehensive IT infrastructure protection, thereby creating a technical problem in existing systems. Cybersecurity threats evolve rapidly and are becoming significantly more sophisticated. Thus, constant system-wide vigilance and anticipatory action are demanded. Nearly as soon as a cybersecurity solution is found that identifies, responds to, and eradicates a threat, those behind the cybersecurity attacks adapt their techniques by using new attack vectors; advanced social engineering ploys; hacking; data theft; and many other deceptive, malicious, and illegal techniques.

Accordingly, the disclosed technology provides a technical solution to the technical problem of identifying and addressing constantly-adapting cybersecurity threats and workflows that can be used to accurately and effectively address those threats. Cybersecurity threat detection is an important task that impacts any industry. An industry, for example, can benefit from the identification of abnormal behavior, which deviates from expected or acceptable, non-threatening behaviors, to proactively detect a threat and respond to that threat before the threat causes significant harm to the industry. Existing systems may use various techniques for detecting potentially malicious network packets and can alert a network administrator to potential problems. The disclosed technology, on the other hand, detects network intrusions and takes real-time remedial actions to proactively prevent network intrusions those remedial actions can also include identifying workflows and best courses of action to effectively and accurately address the detected intrusions and other threats. For example, a cybersecurity detection system may use the disclosed techniques to improve workflows and other actions that can be executed to detect malicious network packets. A difficulty in anomaly detection is that a system must define boundaries between ordinary and anomalous data and accurately classify data as ordinary or anomalous. The line between ordinary and anomalous data may be difficult to determine with cases approaching a boundary and based on an application-specific domain. For example, small variations may trigger an identification of an anomaly in network security for healthcare while relatively larger deviations may be considered normal in less sensitive applications. Furthermore, malicious actors may attempt to make anomalies appear like ordinary activity. Therefore, the disclosed technology provides solutions for using artificial intelligence (AI) to quickly and accurately identify anomalies and thus cybersecurity threats as compared to anomaly detection or other threat detection techniques performed using traditional methods. By automatically detecting network intrusions or other malicious attacks, the disclosed technology enhances network security by allowing for automatic, proactive remediation of network attacks. The disclosed technology realizes an improvement in network security by avoiding delays involved in waiting on a network administrator or other relevant user to react to a network intrusion by automatically performing remedial actions in real-time. As a result, the detected attacks can be addressed in real-time, before the attacks morph and change to avoid detection/response. Furthermore, the human mind is not equipped to practically perform any of the disclosed techniques, such as detecting a threat and responding to a threat before it morphs into another threat. Additionally, the disclosed technology can provide technical solutions to conventional problems with cybersecurity threat detection, mitigation, and prevention through the use of dynamically identified and deployed workflows that permit for more nuanced and accurate analysis of potential threats. For example, while conventional techniques may have relied on more discrete rules to be triggered based on network events, which permit for identification of specific conditions being met based on network activity, the disclosed technology permits for the development, selection, and deployment of more sophisticated workflows that can assess potential threats across multiple different data and temporal dimensions. As a result, instances of false positives can be reduced and additionally attempts by threat actors to obfuscate their attack vectors in manners that would potentially circumvent strictly rule-based approaches to threat detection and prevention can be thwarted.

One or more embodiments described herein can include a computer-implemented method for cybersecurity management including: accessing a group of cybersecurity threat protection applications, the group of cybersecurity threat protection applications being deployed across a managed cybersecurity network, and the group of cybersecurity threat protection applications being managed using a security orchestration, automation, and response (SOAR) platform, executing a cybersecurity workflow, using the SOAR platform, the cybersecurity workflow including instructions to manage three or more of: antivirus analysis, malware attacks, worms, trojans, spyware, browser hijacking, search hijacking, rootkits, ransomware, phishing attacks, security information and event management triage, threat hunting, insider threat protection, threat intelligence, identity verification reinforcement, endpoint protection, forensic investigation, cryptojacking, vulnerability management, cloud security orchestration, and end-to-end incident lifecycle case management, capturing data representing one or more cybersecurity actions that can be performed in response to execution of the cybersecurity workflow, the captured data including reports generated by the SOAR platform, the group of cybersecurity threat protection applications, and network devices, and analyzing the one or more cybersecurity actions for workflow relevance based on providing the one or more cybersecurity actions as input to an artificial intelligence (AI) machine learning model. The AI machine learning model could have been trained to (i) analyze the one or more cybersecurity actions and timings of automated responses in the cybersecurity workflow and (ii) compare the analysis to historic cybersecurity actions and timings of automated responses. The Al machine learning model could have been trained using (i) data from a natural language AI user interface and data, (ii) data from the group of cybersecurity threat protection applications, and (iii) historic cybersecurity events data captured by the SOAR platform. The analyzing further may include: generating multiple versions of the SOAR platform using the AI machine learning model, the multiple versions of the SOAR platform including alternative workflows, reordering of steps in the alternative workflows, added tasks in the alternative workflows, and parallel remedial steps in the alternative workflows, executing each of the multiple versions of the SOAR platform to test potential actions and responses to different cybersecurity threats and application update requirements, and determining, based on executing the multiple versions of the SOAR platform, respective workflow relevance. The method can also include automatically updating, in real-time, the cybersecurity workflow on the SOAR platform based on the analyzing, where updating the cybersecurity workflow can include reordering existing remedial steps in the cybersecurity workflow that can be performed by an Al computer system to improve efficiency and effectiveness of the one or more cybersecurity actions, and executing, in parallel to updating the cybersecurity workflow and in real-time, one or more of the remedial steps of the updated cybersecurity workflow, where executing the one or more of the remedial steps can cause the AI computer system to automatically perform the one or more of the remedial steps.

The method can optionally include one or more of the following features. for example, the method can include automatically executing the updated cybersecurity workflow on the SOAR platform. The one or more cybersecurity actions can be implemented in response to an element of the cybersecurity workflow being executed. The element can include an action initiated by personnel staffing a security operations center. The element can include an action initiated by a separate AI system. The separate AI system can be distinct from the SOAR platform. The one or more cybersecurity actions can be implemented in response to an input from the group of cybersecurity threat protection applications. In response to the analyzing, the method further can include automatically triggering a remedial step action suggestion to be performed by personnel staffing a security operations center, the remedial step action suggestion being provided to and displayed at a computing device of the personnel.

In some implementations, workflow relevance can include identifying a recidivistic security operations center human response to the one or more cybersecurity actions. The recidivistic security operations center human response can be received as input from a computing device of personnel staffing a security operations center. Automatically updating the cybersecurity workflow can include updating the cybersecurity workflow to mimic the recidivistic security operations center human response. The automatically updating can occur in real time. The automatically updating can enable parallel remedial step execution in the cybersecurity workflow that was updated automatically. The automatically updating can cause a reordering of existing remedial steps in the cybersecurity workflow. The analyzing can include evaluation of workflow quality. The evaluation of workflow quality can be based on analysis of repeated incidents having been logged by a security operations center. The evaluation of workflow quality can be based on analysis of operation regression exercises related to a security operations center. The AI machine learning model can be embedded in the SOAR platform and trained using data gathered by one or more instantiations of the SOAR platform. The AI machine learning model can be accessed through an application program interface in the SOAR platform. The cybersecurity workflow further can include non-cybersecurity elements.

A computer-implemented method for cybersecurity management is disclosed including: accessing a group of cybersecurity threat protection applications, the group of cybersecurity threat protection applications being deployed across a managed cybersecurity network, and the group of cybersecurity threat protection applications being managed using a security orchestration, automation, and response (SOAR) platform, executing a cybersecurity workflow, using the SOAR platform, capturing one or more cybersecurity actions, the one or more cybersecurity actions being related to execution of the cybersecurity workflow, analyzing the one or more cybersecurity actions for workflow relevance, and updating the cybersecurity workflow on the SOAR platform, based on the analyzing.

The computer-implemented method can optionally include one or more of the following features. For example, the method can also include executing the cybersecurity workflow that was updated, on the SOAR platform. The one or more cybersecurity actions can be implemented in response to an element of the cybersecurity workflow being executed. The element can include an action initiated by personnel staffing a security operations center. The element can include an action initiated by a separate AI system. The separate AI system can be distinct from the SOAR. The one or more cybersecurity actions can be implemented in response to an input from the group of threat protection applications. The analyzing can trigger a remedial step action suggestion to personnel staffing a security operations center. The workflow relevance can include identifying a recidivistic security operations center human response to the one or more cybersecurity actions. Sometimes, the recidivistic human response can be received from personnel staffing a security operations center. Sometimes, the updating can mimic the recidivistic human response. The updating can occur in real time. The updating can enable parallel remedial step execution in the cybersecurity workflow that was updated. In some implementations, the updating can cause a reordering of existing remedial steps.

As another example, the analyzing can include evaluation of workflow quality. The evaluation of workflow quality can be based on repeated incidents logged by a security operations center. The evaluation of workflow quality can be based on operation regression exercises related to a security operations center. The analyzing can be performed using machine learning. Sometimes, the machine learning can be embedded in the SOAR platform. In some implementations, the machine learning can be trained by data gathered by one or more instantiations of the SOAR platform. The machine learning can be accessed through an application program interface in the SOAR platform. The cybersecurity workflow can include non-cybersecurity elements. Sometimes, the cybersecurity workflow can include managing one or more of antivirus analysis, malware attacks, worms, trojans, spyware, browser hijacking, search hijacking, rootkits, ransomware, phishing attacks, security information and event management triage, threat hunting, insider threat protection, threat intelligence, identity verification reinforcement, endpoint protection, forensic investigation, cryptojacking, vulnerability management, cloud security orchestration, and end-to-end incident lifecycle case management.

One or more embodiments described herein can include a computer program product embodied in a non-transitory computer readable medium for cybersecurity management, the computer program product having code which can cause one or more processors to perform operations of: accessing a group of cybersecurity threat protection applications, the group of cybersecurity threat protection applications being deployed across a managed cybersecurity network, and the group of cybersecurity threat protection applications being managed using a security orchestration, automation, and response (SOAR) platform, executing a cybersecurity workflow, using the SOAR platform, capturing one or more cybersecurity actions, the one or more cybersecurity actions being related to execution of the cybersecurity workflow, analyzing the one or more cybersecurity actions for workflow relevance, and updating the cybersecurity workflow on the SOAR platform, based on the analyzing. The computer program product embodied in the non-transitory computer readable medium can include one or more of the abovementioned features.

One or more embodiments described herein can include a computer system for cybersecurity management, including: a memory which stores instructions, one or more processors coupled to the memory, where the one or more processors, when executing the instructions which are stored, can be configured to: access a group of cybersecurity threat protection applications, the group of cybersecurity threat protection applications being deployed across a managed cybersecurity network, and the group of cybersecurity threat protection applications being managed using a security orchestration, automation, and response (SOAR) platform, execute a cybersecurity workflow, using the SOAR platform, capture one or more cybersecurity actions, the one or more cybersecurity actions being related to execution of the cybersecurity workflow, analyze the one or more cybersecurity actions for workflow relevance, and update the cybersecurity workflow on the SOAR platform, based on the analyzing. The computer system can optionally include one or more of the abovementioned features.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cybersecurity AI-driven workflow modification.

FIG. 2 is a flow diagram for analyzing cybersecurity actions.

FIG. 3 is a block diagram for cybersecurity mitigation management.

FIG. 4 is a system block diagram illustrating AI-driven workflow modification.

FIG. 5 shows a network-connected security orchestration, automation, and

response (SOAR) system.

FIG. 6 shows an example neural network for machine learning.

FIG. 7 shows an example of training a neural network for machine learning.

FIG. 8 is an infographic for cybersecurity workflow management.

FIG. 9 is a system diagram for cybersecurity AI-driven workflow modification.

### DETAILED DESCRIPTION

The threats against digital computer systems and their data have grown in volume and complexity at an alarming rate. Criminals, mischief makers, hostile governments, rival companies, bullies, and other malefactors can wreak havoc on individuals, families, businesses large and small, governments, military installations, infrastructure controls, and so on. Dark web sites and bulletin boards make prewritten malicious code available to individuals with no programming experience, ready to use against unsuspecting targets. The variety of attacks on systems has led to a dizzying array of cybersecurity management applications and platforms. The average business now devotes significant portions of their annual budget to security software, hardware, and staff. Businesses and governments that are in high-risk sectors can often spend more computing power and dollars on security systems than on their core business applications. Cybersecurity activities, including cybersecurity threat management, are designed to protect computing systems, data, networks, and other critical information technology (IT) infrastructure by detecting and countering cybersecurity threats as they arise. Many critical threat protections systems are specific to the particular enterprise or the type of enterprise. Modern threat protections can include biometric verification, two-factor authentication, coded challenges and responses, encrypted or secured communications channels such as virtual private networks, and so on. The enterprises include public and private organizations that can be large, medium, and small in terms of numbers of employees, annual sales, numbers of locations, and the like. The enterprises can include businesses, hospitals, government agencies, research facilities, and universities, among many others. The enterprises are painfully aware that cybersecurity best practices are not merely desirable or “nice to have”. Rather, implementing cybersecurity best practices is essential to the continued operation of, and indeed the survival of, the enterprises. Many of these techniques have found their way into individual homes as part of the newest cell phones, personal computers, laptops, pads, and tablets.

Techniques for cybersecurity management are disclosed. Given the number of cybersecurity threats occurring on a daily basis, and the number of security applications required to counter them, a management system that can access, organize, and manage the wide array of variables is essential. Cybersecurity management can be accomplished using a security orchestration, automation, and response (SOAR) platform that is embedded into a network. The network can include an array of cybersecurity threat protection applications deployed at various levels of the network. The SOAR platform includes application programming interfaces (API) which allow two-way communication between the threat protection applications and the SOAR platform. The APIs are linked to a natural language AI user interface that can accept input from both applications and humans and respond to them in ways that they can readily understand. The SOAR platform also includes an AI machine language model that can take input from network security applications and staff, company policies and regulations, third-party data from other security platforms, recommendations from industry standards groups and partners, previous cybersecurity incidents, regressions tests performed by operations staff, and so on. All of this input can be used to generate application workflows and policies that can be tailored to respond to various cybersecurity threats and routine maintenance tasks. The SOAR platform can include the ability to capture actions and responses taken by cybersecurity applications, operations staff members, users, and third parties as incidents occur and the workflows are executed. The data generated by each workflow run can be analyzed by the machine learning model and compared to established standards and policies. Routine responses from cybersecurity operations staff members, threat management applications, and third-party platforms can be evaluated and mimicked in order to shorten response times. Actions by staff members that lead to subsequent remedial tasks can be identified and eliminated or reported for review. Multiple instantiations of the SOAR platform itself can be generated and used to test alternatives for workflows, including reordering steps, adding or eliminating tasks, and running parallel remedial steps when necessary. Updates to the workflows can be made in real time, so that responses to immediate threats can be countered, even when security staff members are unavailable. As cybersecurity threats continue to escalate, the ability to take all available information, analyze it, and channel it into evolving workflows to combat the threats in real time becomes ever more crucial.

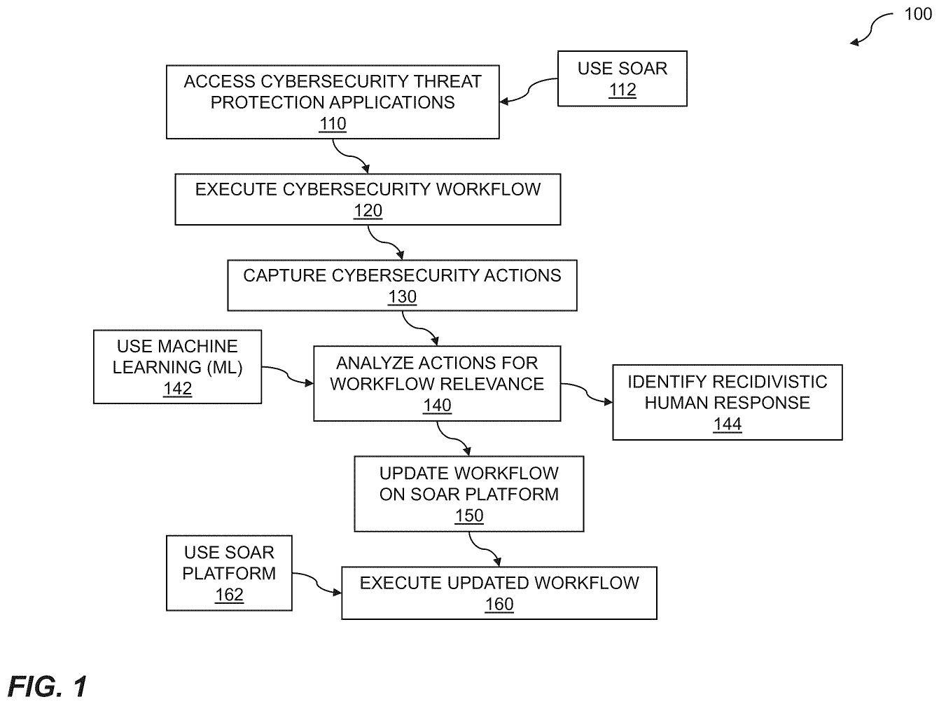

FIG. 1 is a flow diagram 100 for cybersecurity AI-driven workflow modification. The flow 100 includes accessing a plurality of cybersecurity threat protection applications 110, wherein the plurality of cybersecurity threat protection applications is deployed across a managed cybersecurity network, and wherein the plurality of cybersecurity threat protection applications is managed using a security orchestration, automation, and response (SOAR) platform. Threat protection applications can monitor, protect, and defend computer systems, data systems, data networks, handheld electronic devices, and so on against various types of malicious attacks. Malicious attacks can include malware attacks, hacking attacks, denial-of-service attacks (DoS), distributed denial-of-service attacks (DDoS), man-in-the-middle attacks, ransomware attacks, and so on. The threat protection applications can include antivirus and anti-phishing applications, tools for threat hunting and threat intelligence, identity verification, endpoint protection, and so on. The threat applications can further include firewalls and other blocking technology.

Threat protection applications are used to provide a variety of protections and defenses for computer systems, data systems, data networks, endpoint devices, etc. The threat protection applications are installed on the various network-based IT components to counter the increasing variety of malicious cyberattacks. The threat protection applications can include antivirus, anti-phishing, and anti-cryptojacking applications; tools for threat hunting and threat intelligence; identity verification; endpoint protection; forensic investigation; incident management; and so on. In embodiments, the plurality of cybersecurity threat protection applications includes a security orchestration, automation, and response (SOAR) platform 112. The SOAR platform 112 enables the management and maintenance of the cybersecurity threat protection applications, coordinates the coverage of the applications across the network, and handles the analysis and mitigation of cybersecurity events as they occur. The SOAR platform can enable data collection from a wide range of data sources, such as threat data sources, using an artificial intelligence (AI) user interface. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. The SOAR platform can provide threat alerts and can also provide contexts for the alerts. The SOAR platform can further automate responses to threats, adapt the responses using machine learning, and so on.

The flow 100 includes executing a cybersecurity workflow 120, using the SOAR platform. In embodiments, the workflow can include managing one or more, two or more, three or more, four or more, and/or five or more: of antivirus analysis, malware attacks, worms, trojans, spyware, browser hijacking, search hijacking, rootkits, ransomware, phishing attacks, security information and event management triage, threat hunting, insider threat protection, threat intelligence, identity verification reinforcement, endpoint protection, forensic investigation, cryptojacking, vulnerability management, cloud security orchestration, and end-to-end incident lifecycle case management. The workflow can include managing any combination or quantity of events and actions indicated above. In some embodiments, the cybersecurity workflow can include non-cybersecurity elements. As cybersecurity events occur, the cybersecurity threat protection applications log events and report statuses and actions taken to the SOAR platform. The SOAR platform responds with additional requests, commands, communications, and so on as the event progresses. Reporting to incident lifecycle applications, updating security personnel, receiving updates from vendors, modifying application behaviors, and so on can all be a part of the cybersecurity incident. In embodiments, a cybersecurity workflow can include one or more threat protection application actions and responses, as well as interactions with security staff, and artificial intelligence (AI) machine learning model actions and responses. In some embodiments, one or more scripts can be used within the SOAR platform as part of the cybersecurity workflow. Previous cybersecurity incidents can be used to model various actions and responses taken by threat protection applications, security staff, third-party security platforms, and the SOAR platform in order to construct cybersecurity workflows to mitigate threats and preparing for future events.

The flow 100 includes capturing one or more cybersecurity actions 130, wherein the one or more cybersecurity actions are related to execution of the cybersecurity workflow. In embodiments, as the cybersecurity workflow proceeds, log entries, reports, and discrete responses from the SOAR platform, threat protection applications, third-party applications, workstations, network devices, security staff, and so on can be captured and forwarded to an AI machine learning model. The machine learning model can analyze the actions, responses, and timings of the human and digital participants in the cybersecurity workflow and compare them to previous events, response times, and so on. For example, an antivirus security application can detect a virus in a file on a workstation. The virus detection can be logged by the antivirus component on the workstation, and the antivirus server engine can be notified by a message sent over the network. The antivirus server engine can log the workstation event, notify the SOAR platform via a message sent over the network, and direct the workstation to quarantine the file in which the virus was detected. The SOAR platform can log the message from the antivirus server, access a relevant cybersecurity workflow for virus mitigation, add all log entries and actions taken by the antivirus server and workstation to the workflow log, and report the virus detection to security personnel. The security personnel can contact the user of the workstation, note the contact in a log entry within the SOAR platform, and deploy service personnel to replace or regenerate the workstation, if necessary. The SOAR platform can check with the antivirus vendor site to look for virus library updates, virus detection engine updates, and so on. The SOAR platform can also direct the antivirus server engine to deploy the most recent virus library updates to all workstations in the network, or to a subset of workstations running the same operating system, or the same application suite. All of these log events and actions, including the time required to complete each action, can be captured and analyzed by the AI machine learning engine as part of the cybersecurity workflow analysis.

The flow 100 includes analyzing the one or more cybersecurity actions for workflow relevance 140. In embodiments, the analyzing is performed using machine learning 142 embedded in the SOAR platform. The machine learning 142 can be trained by data gathered by one or more instantiations of the SOAR platform. The machine learning can be accessed through an application program interface (API) in the SOAR platform. A machine learning (ML) model can be built using data from a natural language AI user interface and data from the cybersecurity threat protection applications through one or more APIs. Previous cybersecurity events occurring on the network and captured by the SOAR platform can be used as training data. Multiple instantiations of the SOAR platform can be generated to test and refine actions and responses to various cybersecurity threats, application update requirements, actions taken by users and/or operations security staff members, and so on. As cybersecurity events occur, either within the SOAR-managed cybersecurity network or on other similar networks across the globe, incident reports in various forms are published by threat protection application vendors, regulatory agencies, auditors, watchdog agencies, internal audit and compliance departments, IT departments, and so on. All of this input can be used to update and refine cybersecurity workflows, policies, rules, and application settings.

In embodiments, one or more cybersecurity actions can be taken in response to an element of the cybersecurity workflow being executed. The element can include action initiated by personnel staffing a security operations center. The element can be an action initiated by a separate AI system, wherein the separate AI system is distinct from the SOAR platform. For example, a relationship between the SOAR platform and a separate security platform that monitors antivirus applications and their effectiveness against various threats can be used to generate actions including a recommendation to use a different security application within the SOAR-managed network. Or a separate security platform can recommend a change in the settings of an existing security application on the SOAR-managed network. The one or more cybersecurity actions can be in response to an input from the plurality of threat protection applications. In some embodiments, the cybersecurity actions can include remedial step action suggestions to security operations staff members. Cybersecurity workflows can include interactions with human security operations staff members. For example, a cybersecurity workflow related to antivirus library updates can include a step to receive confirmation from a member of the security operations staff before downloading an update from the application vendor. An analysis of previous executions of the workflow can reveal that the security operations staff occasionally fail to send a confirmation to the SOAR system allowing the update to proceed. Eventually, the request to update the library is always approved, but the delay in receiving the confirmation can introduce unnecessary risk of infection to the network. As a result, the analysis can recommend that the approval of library updates be automated, with a notification sent to the cybersecurity operations staff, rather than waiting for approval by the operations staff. In some embodiments, the notification from the SOAR system can include an option for the security operations staff to override the decision to install the update, or to reschedule the timing of the update.

In embodiments, the analyzing includes evaluation of workflow quality. The evaluation can be based on repeated incidents logged by the security operations center. The evaluation can be based on operations regression exercises related to security operations center. The analyzing can include identifying one or more recidivistic security operations center human responses 144 to one or more cybersecurity events. The recidivistic human response can be received from personnel staffing a security operations center. For example, the SOAR system can detect that an update to a firewall application used by the network is available and recommended by the vendor. The SOAR platform can log this update and initiate a related workflow to update the network firewall. In some embodiments, the firewall workflow update can be running in a background mode and become active when a vendor update becomes available. The cybersecurity workflow can include a message to the security operations staff informing them of the firewall update and recommending that it be installed. The recommendation can include a scheduled time for the update, along with an estimate of how long the update may take. The workflow can require a response from the security operations staff before the firewall update can be scheduled and implemented. An analysis of previous instances of this firewall workflow can reveal that the security operations staff always approves the installation of the update and schedules the update as part of an existing weekly maintenance cycle for network security devices. The result of the analysis can be to automate the scheduling and automation of the firewall updates and generate a notice to the security operations staff of the update and scheduled installation. In some embodiments, the workflow can include the option for the operations security staff to override the decision to install the update or modify the timing of the update.

The flow 100 includes updating the cybersecurity workflow on the SOAR platform 150, based on the analyzing. In embodiments, the updating can enable parallel remedial step execution in the workflow that was updated. The updating can include mimicking the recidivistic human responses. The updating can cause a reordering of existing remedial steps. In some embodiments, the updating can occur in real time. The goal of updating the cybersecurity workflow is to improve the efficiency and effectiveness of the actions taken by threat protection applications, third-party applications, security operations staff, and users, thereby increasing productivity and preventing data loss. The AI machine learning model can implement multiple instantiations of the SOAR platform in order to test multiple iterations of workflows, comparing and contrasting response times and effectiveness, identifying delays due to security operations staff, third-party applications, network downtime, maintenance windows, and so on. The machine learning model can vary the order of steps in the workflow, measure time saved by automating human security staff responses, identify actions by staff members, applications, or the SOAR platform that resulted in remedial steps being taken at a later time, and so on. For example, a human security operations response can be required in a cybersecurity workflow in order to authorize a security update to be forwarded to all remote desktop and laptop users running a particular operating system. The vendor supplying the security update may release the update for downloading at 12:01 PM local time. However, the cybersecurity operations staff may not begin work until 7:00 AM the following morning. The security update may be routine and therefore not scheduled to be made available to workstations until 7:00 PM of the day on which the update is authorized by the operations staff. Therefore, in the best case, the update will not be available to the user workstations until 19 hours after it has been made available. The machine learning model can analyze the workflow and find that in 90 percent of executions, the operations staff authorizes the update to be installed as soon as possible. The machine learning model can recommend that the human response by the operations staff be replaced with an automated response in the affirmative. In addition, a notification to the security operations staff can be added to the workflow, including an option to deny the installation of the update or reschedule it. Allowing the update to be uploaded immediately to those workstations that are connected to the network can improve efficiency and reduce the risk of virus infection. In some embodiments, the SOAR platform can be managed so that some workflow updates can be implemented in real time, with a follow-up notification to the security operations staff. This can be especially useful when cybersecurity attacks occur during off-hours, long weekends, etc. The network operations security staff can decide which workflows can be updated automatically and which must be approved prior to change.

The flow 100 includes executing the cybersecurity workflow that was updated 160. The updated workflow can be executed on the SOAR platform 162. In embodiments, the SOAR platform can be used to execute updated workflows using operations regression test variables, previous incidents, scenarios supplied by third-parties, interactions with security operations staff, and so on. The machine learning model can compare the updated workflow efficiency and effectiveness to the previous version of the workflow as well as alternate versions supplied by external or internal sources. In some instances, the SOAR platform can execute the updated workflow using a routine schedule previously established for the workflow. For instance, a weekly update of phishing attack vectors from a third-party security platform can be run ad hoc by the SOAR platform to confirm functionality and test any changes made to the workflow in production mode. In some embodiments, a comparison report showing the updated workflow alongside the previous version can be generated, including times, responses, and calculated changes in efficiency.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

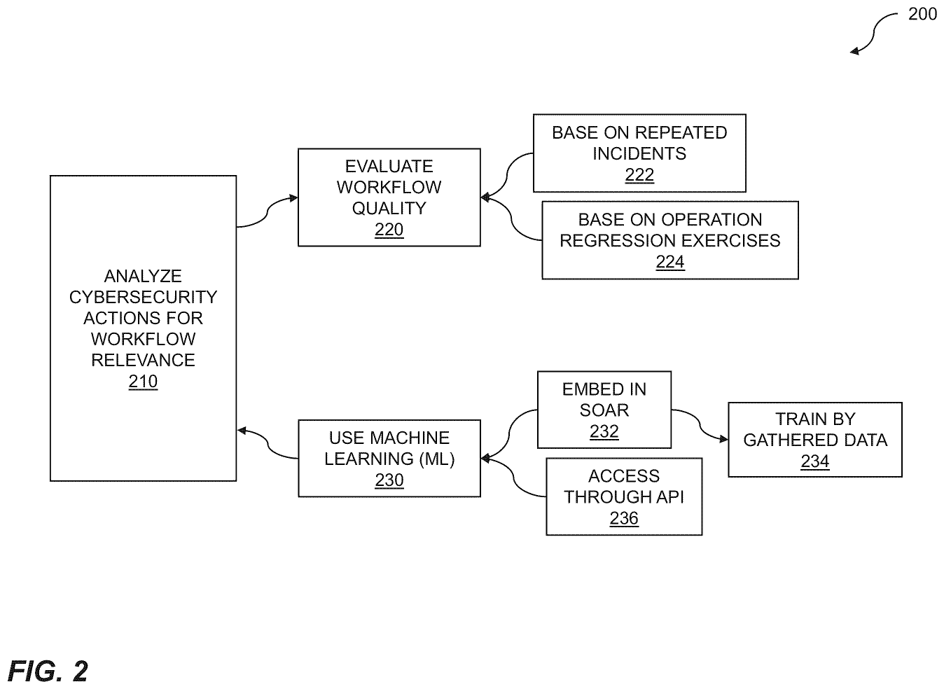

FIG. 2 is a flow diagram 200 for analyzing cybersecurity actions. As mentioned above and throughout, a SOAR-managed network can be accessed. The network can include a plurality of cybersecurity threat protection applications that are deployed and managed by the SOAR platform. The SOAR platform can include one or more application program interfaces (API) that allow the SOAR platform to send and receive data from the threat protection applications. The SOAR platform can also contain one or more APIs to communicate with human security operations staff and third-party application and security platforms. The SOAR platform can include an artificial intelligence (AI) machine learning model. The AI machine learning model can include a natural language processing (NLP) interface. Natural language processing (NLP) is a field of computer science, artificial intelligence (AI) and linguistics that deals with the interactions between human language and computers. Its goal is to give computers the ability to understand, generate, manipulate, and respond to text and speech data in natural human languages. NLP can use rule-based and statistical models, as well as machine learning and deep learning techniques, to process and analyze large amounts of natural language data. In recent years, advances in data grouping and summarization have allowed massive amounts of human text and speech to be fed into very large databases used by machine learning models to analyze and generate human language. In embodiments, the natural language Al user interface can be embedded in the SOAR platform, wherein the natural language AI user interface is accessed by an application program interface (API) in the SOAR platform. An application program interface (API) is a set of programs and rules that allow different applications to exchange information. It acts as an intermediate layer that processes data between systems, allowing application data and functionality to extend to third-party developers as well as to internal departments within the same network.

In embodiments, one or more APIs can be used to accept data from the one or more cybersecurity threat protection applications into the natural language AI user interface. The API can also be used to send requests for data and commands to the cybersecurity threat protection applications. The natural language AI user interface can be accessed using text and/or voice. Cybersecurity workflows can be designed or edited using the AI machine learning model, including the natural language AI user interface. The input can be done verbally or in written word. Input from the cybersecurity threat protection applications can use the API into the natural language AI user interface as well. The input from all of these sources into the AI user interface can enable the SOAR platform to converse programmatically with the cybersecurity threat protection applications, interpret their data, respond to their input, and manage the tasks undertaken by the applications as they react to cybersecurity events. In embodiments, the cybersecurity workflows can be used to coordinate actions to mitigate threats, update security applications and network hardware, generate reports, update security operations staff, interact with operations staff, communicate with third-party security applications and platforms, and so on. The cybersecurity workflows can be used as part of the training database for the AI machine learning model. Multiple instantiations of the SOAR platform can be used to train the AI machine learning model, test and refine workflow modifications, and update workflows automatically or in concert with security operations staff.

The flow 200 includes analyzing the one or more cybersecurity actions for workflow relevance 210. In embodiments, the analyzing is performed using machine learning 230, wherein the machine learning is embedded in the SOAR platform 232. Machine learning is a form of artificial intelligence (AI) that can use data and algorithms to imitate the way humans learn, improving its accuracy and performance over time. In embodiments, a training database can be established using input from cybersecurity applications, previous cybersecurity incidents, third-party reports, application logs, security staff, corporate policies, government regulations, and so on. Workflows can be generated using the natural language API embedded in the SOAR platform to accomplish various cybersecurity tasks, such as mitigating a virus threat, updating a firewall application, verifying the security software suite on a remote user workstation, and so on. The workflows can be added to the AI machine learning training database.

In embodiments, the analyzing can include an evaluation of workflow quality 220. As cybersecurity incidents occur, actions taken by the threat protection applications, operations staff, third-party applications, and the SOAR platform can be captured, including timings and outcomes. The results of each workflow execution can be compared to standards established by third parties, internal policies, government regulations, and so on. Comments and other input can be added by security operations staff using the machine learning model API 236 embedded in the SOAR platform. The machine learning model can be trained 234 by data gathered by one or more instantiations of the SOAR platform. Multiple instances of the SOAR platform can be generated and used to test various options and alternate versions of cybersecurity workflows. Input from previous cybersecurity events 222 and operations regression exercises 224 can be used to train the Al machine learning model and improve performance. Steps within each workflow can be re-ordered, added, or eliminated in order to generate the most efficient and effective means of completing each workflow.

The analyzing 210 can include cybersecurity actions that are implemented in response to input from the plurality of threat protection applications. The analyzing can include actions taken by personnel staffing a security operations center. Cybersecurity threat protection applications can require interaction with users or security operations staff before taking actions that may impact a workstation, application, or data. In embodiments, the natural language API can capture the messages, logs, and data sent by the threat protection application, as well as the responses to the applications from the operations staff or users. These interactions can be used as part of the training of the AI machine learning model in order to improve the quality of cybersecurity workflows. In some embodiments, users, operations staff, or the SOAR platform may take actions, change schedules, or make choices with regard to threat protection applications that must later be mitigated or altered in order to safely complete a workflow. Remedial step actions can be generated by the SOAR platform machine learning model and presented to the cybersecurity operations staff as recommendations or suggestions in order to more efficiently complete workflows. In some embodiments, the remedial step actions can be incorporated into updated versions of cybersecurity workflows. For example, a user or operations staff person may choose to delay a virus scanner update on a workstation until after normal work hours. In low threat situations, this can be a valid option. However, when a virus has been detected as being active within the network, workstation scanner updates can become a more immediate priority. The AI machine learning model can generate an update to the virus scanner update workflow that considers the current virus threat level within the network and initiate an immediate scanner update on the workstation, while notifying the user and operations staff of the reason for the change in timing.

The analyzing 210 can include identifying a recidivistic security operations center human response to one or more cybersecurity actions included in a workflow. In embodiments, the recidivistic human response can be received from personnel staffing a security operations center. In embodiments, some cybersecurity workflows can be executed repeatedly. Updates to cybersecurity applications, firmware, and hardware, scheduled virus scans, installations of security software onto new workstations, reviewing relevant regulatory or policy statements from internal and external sources, and so on can be executed multiple times each week or month. In many cases, the responses to the SOAR platform generated by human cybersecurity operations staff can be the same each time a particular workflow is executed. For example, permission to install a virus library upgrade to the server hosting the application engine is always granted, threat intelligence reports from trusted third-party sites are always ingested for review by the NLP user interface, incident case management reports are routinely reviewed and signed off by the relevant case officer, and so on. Over time, as cybersecurity workflows are executed and recidivistic responses from users or security operations staff are recorded, the AI machine learning model can identify the routine human replies and suggest updates to the workflow that can automate the human responses. For example, the installation of a virus library upgrade can be scheduled and executed automatically rather than waiting for a security officer response, threat intelligence reports can be ingested automatically, and so on. In some embodiments, notices to the security operations staff can be generated, allowing the option to override or reschedule the routine installation of a virus library, or to accept third-party reports, for example. In some embodiments, the security operations staff can choose not to accept suggestions from the AI machine learning model. For example, the incident case management reports still need to be read and signed off by the case officer, even when the action is routinely completed in the same way. The result is that as more executions of cybersecurity workflows are completed and analyzed by the SOAR platform using the embedded AI machine learning model, the more efficient and effective the workflows can become. Cybersecurity operations staff can learn from regression exercises, multiple instantiations of the SOAR platform can be employed to test workflow options and train the machine learning model, input from third-party security platforms can be ingested, regulatory and compliance data can be analyzed, and so on to continually refine and improve workflows as they are used to protect and defend digital networks from both internal and external threats.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

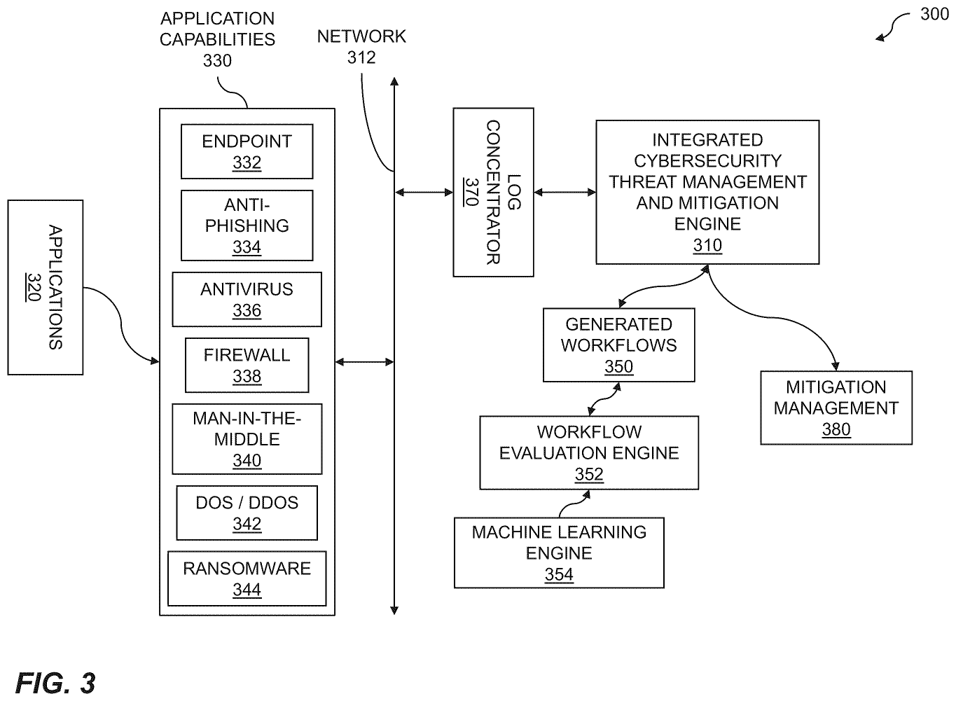

FIG. 3 is a system block diagram 300 for cybersecurity mitigation management. The SOAR platform generates and manages cybersecurity workflows based on data from cybersecurity threat protection applications, internal and external IT cybersecurity policies, regulations, compliance rules and requirements, company policies, user comments, and cybersecurity events. The input from the internal and external sources is fed into a machine-learning model through an AI user interface. The AI user interface uses an embedded natural language processor that can accommodate text and voice data. The machine learning model analyzes the compliance and regulatory requirements and generates workflows that can be executed by the cybersecurity threat protection application in response to cybersecurity events as they occur. The workflows are designed to ensure that the cybersecurity events are mitigated in accordance with the associated compliance and regulatory standards. Threat management such as cybersecurity threat management includes detecting new cybersecurity threats and assigning those threats to one or more analysts for action. Workflows are evaluated for efficiency and effectiveness each time they are executed. Additional input from cybersecurity staff, policy and regulatory requirements, regression testing, and threat mitigation applications is fed into the machine learning model and adjustments are made to the workflows to improve functionality. Cybersecurity management is accomplished by an integrated cybersecurity threat management and mitigation engine. The mitigation management system is part of a SOAR platform. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. A cybersecurity threat response is generated, and the results are tracked and used to update the machine learning model database in order to assess the threat response and improve subsequent responses.

An example system block diagram 300 for threat management is shown. Threat management such as cybersecurity threat management is critical to an organization. The cybersecurity threat management is used to monitor operations such as data operations within the organization. When anomalies or outright threats are detected, threat management applies a variety of techniques to determine the cause of an anomaly, a source of a threat, and responses to the anomalies and threats. The block diagram 300 can include an integrated cybersecurity threat management and mitigation engine 310. The management and mitigation engine can access applications; collect and ingest log files from the applications; sort, integrate, and evaluate threat protection elements; and so on. The engine can include one or more processors, processor cores within integrated circuits or chips, CPUs, GPUs, and so on. The management and mitigation engine can be coupled to a network 312 such as a computer or cybersecurity network. The network can be based on wired and wireless communications techniques.

The block diagram 300 can include a plurality of applications 320. The applications can include network-connected cybersecurity threat protection applications. The applications can perform tasks such as network and processor monitoring; data integrity monitoring; data, services, and physical access control; etc. Some applications within the plurality of threat protection applications can perform unique tasks, similar or redundant tasks, and the like. The applications within the plurality of cybersecurity threat protection applications can include application capabilities 330. The application capabilities can include endpoint protection 332. Endpoint protection can include authentication and supervision of “endpoint” devices. The endpoint devices can include desktop computers, laptop computers, tablet computers, personal electronic devices such as smartphones and PDAs, and so on. Endpoint protection can include enabling access of the endpoint devices based on one or more rights. Access rights can include creating, editing, and deleting files, folders, and so on. Access rights can include read-write, read-only, write-only (e.g., a drop box), etc. Endpoint protection can restrict access, impose security rules, and the like.

Application capabilities can include anti-phishing 334 techniques. “Phishing” threats can be based on sending fraudulent email messages, where the messages appear to be from a legitimate sender who may be known to the recipient. The messages are used to gather sensitive, identifying information about an individual which is then used to defraud the individual. The application capabilities can include antivirus 336 techniques. Antivirus techniques can be used to detect viruses that can be embedded in data such as images, audio files, and so on. The application capabilities can include firewall 338 techniques. Firewall techniques can be used to block network traffic, applications, etc. that can attempt to penetrate a network and IT infrastructure using one or more network ports and communications protocols. The application capabilities can include man-in-the-middle detection and prevention techniques 340. A “man-in-the-middle” cybersecurity threat includes interception of communications between a user or endpoint device and an entity with which the user or endpoint device is trying to communicate. The communications interception attempts to extract personal or identifying information from the communications for fraudulent purposes. The application capabilities can include denial-of-service (DOS) and distributed denial-of-service (DDOS) 342 detection techniques. Denial-of-service attacks attempt to render a website, computer, processor, and so on unreachable or unusable by overwhelming it with requests. The application capabilities can include ransomware 344 detection techniques. Ransomware attacks encrypt a victim's data. The encrypted data is only decrypted, if at all, after payment of a ransom.

The cybersecurity threat management and mitigation engine 310 can include an artificial intelligence (AI) user interface. In embodiments, the AI user interface can include a natural language processing (NLP) user interface. The AI user interface can input and output text and/or voice data using human-like language based on the NLP user interface. The AI user interface can be used to assimilate one or more cybersecurity network compliance requirements into the integrated cybersecurity threat management and mitigation engine as part of the SOAR platform. In embodiments, the compliance requirements can be based on one or more compliance standards, regulatory requirements, company policy documents, and company incident response documents. The AI user interface can also accept input and transmit output to the cybersecurity threat protection applications 320. In some embodiments, the network can include an embedded universal data layer comprising two or more cybersecurity threat protection application mappings. The first mapping of the two or more cybersecurity threat application mappings includes a transformation of outputs of each of the plurality of cybersecurity threat applications. The second mapping of the two or more cybersecurity threat application mappings includes a transformation of inputs of each of the plurality of cybersecurity threat applications. The universal data layer (UDL) can be used to “standardize” data provided to or generated by the cybersecurity threat protection applications. The applications can use different but similar terms to describe or label a threat, an action, a result, and so on. In a usage example, a security threat event such as detection of a virus or trojan can cause one application to generate a signal such as “security threat detected”, while a second application can generate a signal such as “virus detected”. Since the different labels are used by the different applications to indicate a substantially similar threat event, the two labels can be standardized. For example, “security threat detected” and “virus detected” can be standardized to “integrity threat” or similar. In embodiments, the SOAR platform can manage cybersecurity for a data network, based on data collected through the first UDL mapping and data transmitted through the second UDL mapping.

The cybersecurity threat management and mitigation engine 310 can include a machine learning engine 354. The machine learning engine 354 can analyze the cybersecurity network requirements that are input through the AI user interface and the input data, logs, reports, and so on from the cybersecurity threat protection applications 320 to generate cybersecurity workflows 350 for the SOAR-managed network 312 based on the cybersecurity network requirements. The generating of the cybersecurity workflows is performed by the machine learning engine 352, which is embedded in the SOAR platform and trained by the data gathered by one or more instantiations of the SOAR platform.

The block diagram 300 can include one or more mitigation responses generated by the integrated cybersecurity threat management and mitigation engine 310. The generated responses can be provided to a cybersecurity mitigation management entity 380. A cybersecurity mitigation management entity can include a human-based entity, a machine-based entity, or a combination of human-based and machine-based entities. In embodiments, the cybersecurity mitigation management entity can be a cybersecurity professional. The cybersecurity professional can be an employee of an organization, a consultant to the organization, and so on. In other embodiments, the cybersecurity threat management entity can be a security orchestration, automation, and response (SOAR) application. The SOAR application (or SOAR platform) can handle threat detection, response generation, case tracking, and so on. The system block diagram can include a log concentrator 370. The log concentrator can sort a plurality of log files, can integrate the log files, and so on. The concentrator can extract key information from the log files. The concentrator can compress log file data.

In embodiments, cybersecurity threat events can generate multiple inputs from the plurality of threat protection applications 320 with multiple application capabilities 330. The inputs from the applications can be fed into a log concentrator 370 that can normalize the inputs, place them in time sequence, and forward them to the integrated cybersecurity threat management and mitigation engine 310. The threat management and mitigation engine 310 can use the application inputs to track ongoing mitigation responses based on the cybersecurity threat protection application workflows and statuses of various components and applications involved in a cybersecurity threat event and can compare timings and other parameters of the application responses. The application inputs can also be recorded by the machine learning engine to update its database as new events and mitigation steps are employed by the mitigation management threat management and mitigation engine 310, and human cybersecurity professionals to provide mitigation management 380, which can be implemented as part of a SOAR platform.

The block diagram 300 can include a workflow evaluation engine 352. The workflow evaluation engine 352 can capture inputs and outputs from the cybersecurity threat protection applications, security operations staff, users, network hardware and firmware, and other elements of the SOAR platform each time a cybersecurity workflow is executed. The actions, responses, timings, and other data collected from each workflow run can be combined with regression testing by the cybersecurity operations staff, previous workflow runs, operations staff input, policy and regulatory reports, third-party security platform data, and so on to analyze and evaluate the efficiency and effectiveness of cybersecurity workflows. Multiple instantiations of the SOAR platform can be generated to allow testing and refinement of workflows. The workflow evaluation engine 352 can use the integrated machine learning engine to update the workflows and continuously evaluate and refine them.

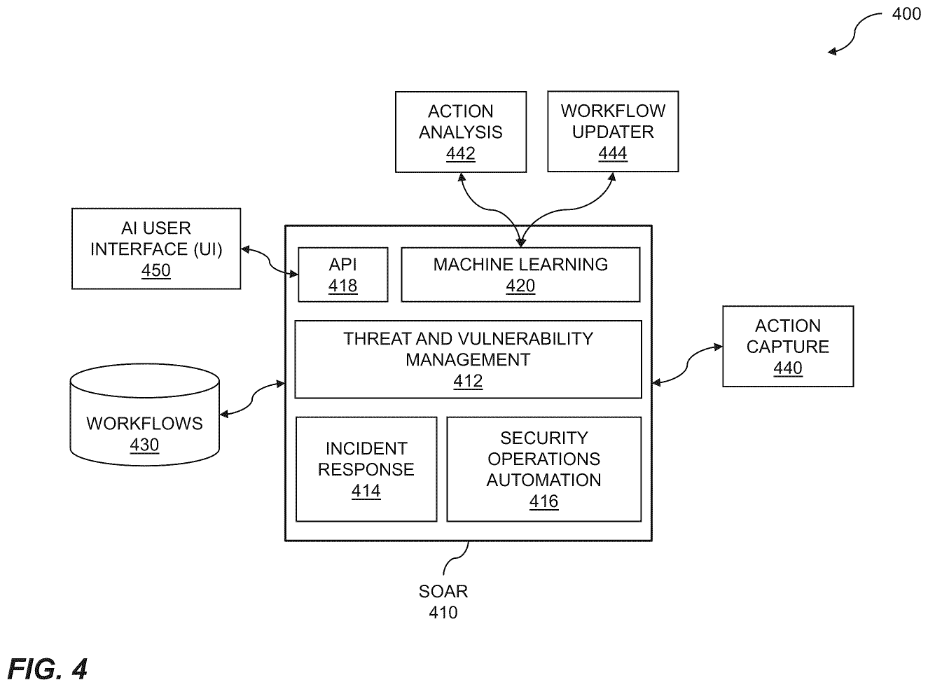

FIG. 4 is a system block diagram illustrating AI-driven workflow modification.

As mentioned above and throughout, a plurality of cybersecurity threat protection applications can be deployed across a managed security network. The cybersecurity threat protection applications can be managed by a SOAR platform. The SOAR platform can include a threat and vulnerability management engine. Compliance and regulatory data, cybersecurity events managed by the SOAR platform, security operations regression testing, security staff input, and other sources can be fed into an AI user interface included in a machine learning model. The AI user interface can use natural language processing (NLP) to take in and interpret the text and verbal information from the internal and external sources and use it to populate a machine learning model. The cybersecurity threat protection applications can add data to the machine learning model using an application program interface (API). The machine learning model can analyze the contents of the various sources and generate software application policies and workflows for the cybersecurity threat protection applications to use in responding to cybersecurity events. As cybersecurity events occur, the threat and vulnerability management engine can use incident response and security operations automation systems to mitigate the cybersecurity threat; capture application, third-party, and security operations staff actions and responses; analyze the actions and responses; and generate updates to the workflows as needed to address any gaps between the cybersecurity incidence responses and the requirements of the network. The necessary changes can be made through the security operations automation system, and the machine learning model database can be updated accordingly.

The block diagram 400 includes a security orchestration, automation, and response (SOAR) platform 410. The SOAR platform 410 can access and manage one or more cybersecurity threat protection applications that are deployed across a managed cybersecurity network. The SOAR platform can enable data collection from a wide range of data sources such as threat data sources. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. on a network-connected computer platform. The SOAR platform can provide threat alerts and can also provide contexts for the alerts. The SOAR platform can further automate responses to threats, adapt the responses using machine learning, and so on. The SOAR platform can use a library of cybersecurity mitigation success metrics to compare timing and effectiveness of mitigation steps to previous events and successful mitigation processes.

The block diagram 400 includes an artificial intelligence (AI) user interface 450. The Al user interface comprises a natural language processing AI user interface. In embodiments, the natural language AI user interface can be accessed by an application program interface (API) 418 in the SOAR platform 410. An application program interface (API) is a set of programs and rules that allow different applications to exchange information. It acts as an intermediate layer that processes data between systems, allowing application data and functionality to extend to third-party developers as well as to internal departments within the same network. In embodiments, one or more API programs can be used to accept data from the one or more cybersecurity threat protection applications into the AI user interface 450. The API can also be used to send requests for data and commands to the cybersecurity threat protection applications. The natural language AI user interface can be accessed using text and/or voice. The natural language Al user interface can be engaged by cybersecurity operations staff. Input from the cybersecurity threat protection applications can use the API into the natural language AI user interface as well. The input to AI user interface 450 can include non-verbal prompts such as diagrams, or it can be in the form of changes made to cybersecurity workflows by a human agent. The input from all of these sources into the database of the AI user interface can enable the SOAR platform to converse programmatically with the cybersecurity threat protection applications, interpret their data, respond to their input, and manage the tasks undertaken by the applications as they react to cybersecurity events.

The block diagram 400 includes a machine learning model 420. The machine learning model (ML) 420 is embedded in the SOAR platform 410, wherein the ML is trained by data gathered by one or more instantiations of the SOAR platform. The ML can be accessed through an application program interface (API) 418 in the SOAR platform. A machine learning (ML) model can be built using data from the natural language AI user interface 450 and data from the cybersecurity threat protection applications input through one or more APIs. The data from previous cybersecurity events, operations regression testing, third-party security platforms, regulatory information, and so on can be augmented by input from cybersecurity operations staff, from publicly available cybersecurity threat applications, and from company policy documentation. As cybersecurity events occur, either within the managed cybersecurity network or on other similar networks across the globe, incident reports in various forms are published by threat protection application vendors, regulatory agencies, auditors, watchdog agencies, internal audit and compliance departments, IT departments, and so on. All of this input can be used to update and refine the translation of network compliance requirements into policies, rules, and application settings. The input can be introduced into the machine learning model using one or more APIs 418 and/or through the AI user interface 450.

In embodiments, the machine learning model 420 can generate a set of application policies, workflows 430, rules, and settings, for each of the cybersecurity threat protection applications that direct the applications to respond to cybersecurity events in a manner that is consistent with the security requirements for the network. The generating of the cybersecurity workflows 430 is performed by the ML model, which is embedded in the SOAR platform and trained by the data gathered by one or more instantiations of the SOAR platform. The cybersecurity workflows can include managing one or more of antivirus analysis, phishing attacks, security information and event management (SIEM) triage, threat hunting, insider threat protection, threat intelligence, identity verification reinforcement, endpoint protection, forensic investigation, cryptojacking, vulnerability management, cloud security orchestration, and end-to-end incident lifecycle case management. The cybersecurity application workflows 430 can include information on how to respond to specific types of threats, how often to report operational status, how often and when to install updates, whom to notify during priority events, how to notify, and so on. Cybersecurity application policies can include details on which processes are to be handled by the SOAR platform, so that only condition and status data is sent forward to the SOAR platform, and which processes are to be handled by the application directly, with status data to follow. The application policies can include settings on how the application is to proceed in the event that the SOAR platform is unavailable, and so on.

The block diagram 400 can include one or more components associated with cybersecurity threat management. The SOAR platform can include a threat and vulnerability management component 412. The threat and vulnerability management component can configure and control IT infrastructure elements such as routers, switches, processors, storage area networks (SANs), and so on. The block diagram 400 can include an action capture component 440. The action capture component 440 can capture data generated by cybersecurity threat management applications, operations staff, third-party security applications and platforms, and so on, as cybersecurity events occur, and the SOAR platform and SOAR-managed components respond to the events. The SOAR platform can include an incident response component 414. The incident response component can provide alerts, can trigger one or more actionable responses, and the like. In embodiments, the actionable response can enable scalability of a connected SOAR platform. The SOAR platform can be scaled up to address many threats, to reduce threat response time, etc. In embodiments, the actionable response can include a recommendation for cybersecurity operations staff. The recommendation can include a recommendation for a threat response policy, a source for further information about the threat, etc. The block diagram 400 can include an action analysis component 442. The action analysis component 442 can analyze the actions captured 440 as part of the SOAR incident response 414 and generate updates 444 to the cybersecurity workflows to improve their efficiency and effectiveness.

The block diagram 400 can include security operations automation 416. Security operations management can include automatically securing IT infrastructure elements such as switches, routers, processors, storage elements, etc., where the securing can be based on a procedure, a policy, and so on. The security operations automation can include updating IT element software and firmware, installing and configuring security software such as antivirus software, and the like. Cybersecurity threat application inputs can include alerts, text or SMS messages, email, a rendering on a graphical display, and so on. The analysis can be based on metadata associated with the plurality of inputs from the cybersecurity threat protection applications. The metadata can include a variety of status and other information such as a time and a frequency of cybersecurity threat protection application inputs, one or more techniques used to receive the application inputs, who or what tool provided the application inputs, etc. The mitigation response can include a workflow that can be developed to address, rectify, remediate, prevent, etc. the cybersecurity threat. The cybersecurity threat response can address various types of events such as a zero-day event.

In embodiments, executing cybersecurity workflows 430 can include tagging a cybersecurity incident, as part of the incident response 414 process, when a mismatch between the incident response and network security requirements occurs. As cybersecurity events occur, the cybersecurity threat protection applications log events and report statuses and actions taken to the SOAR platform. The SOAR platform responds with additional requests, commands, communications, and so on as the event progresses. Reporting to incident lifecycle applications, updating security personnel, receiving updates from vendors, modifying application behaviors, and so on can all be a part of the cybersecurity incident. As the incident progresses, the action capture component 440 and the action analysis components 442 capture and feed the actions and responses to and from the SOAR platform and the application threat management applications to the Al machine learning model 420. As the analysis progresses, mismatches between established compliance standards and internal policies specific to an enterprise or agency may be revealed, resulting in one or more tags being applied to the recording of the incident in the SOAR platform database. Multiple instantiations of the SOAR platform can be generated to test various alternatives to the current workflows 430 in order to remedy any deficiencies, improve efficiency, address recidivistic responses from operations staff or third-party security platforms, and so on. Defects in the application policies, processes, applications, or staff responses can be tagged and reported to cybersecurity team members and/or audit and compliance officers using threat and vulnerability management 412 so that updates to the workflows 444 can be reviewed and the cybersecurity threat protection responses can be validated. In some embodiments, the follow-up steps can be accomplished using security operations automation 416 as part of the SOAR platform. The event history logs, communications, and reporting can also be added to the ML model database 420 in order to improve the responses and application policies in subsequent events.

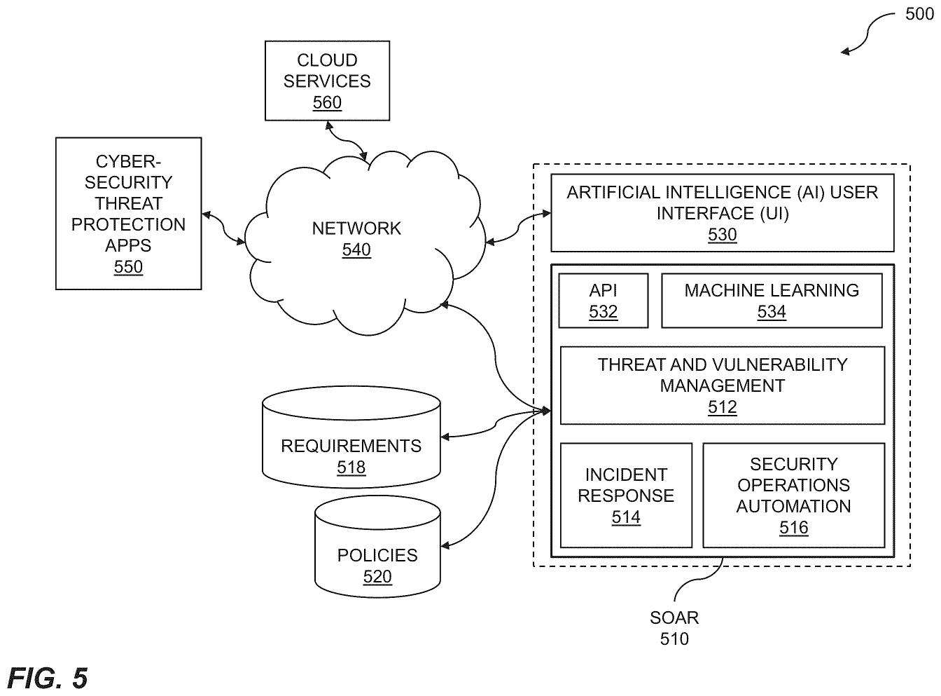

FIG. 5 shows a network-connected security orchestration, automation, and response (SOAR) system. Discussed above and throughout, cybersecurity threats can occur as often as every few seconds. These threats target individual users, businesses, universities, hospitals, government agencies, and so on. The cybersecurity threats constitute extreme menaces, and indeed existential crises, to the enterprises. Cybersecurity threat management includes identifying that a threat is underway, what IT infrastructure and data are under attack, the type of threat, etc. The cybersecurity threat management ideally then proceeds to block and remove the threat, isolate affected infrastructure, perform eradication or remediation, and the like. Cybersecurity management is enabled by cybersecurity mitigation and completion confirmation management along with threat and vulnerability management. A plurality of network-connected cybersecurity threat protection applications is accessed. A plurality of inputs is received from the cybersecurity threat protection applications, wherein the plurality of inputs is initiated by one or more cybersecurity events. A network-connected computer platform is used to analyze the plurality of inputs and the metadata associated with the plurality of inputs from the cybersecurity threat protection applications. The inputs are analyzed by the threat and vulnerability management element. A cybersecurity threat mitigation workflow is generated based on the analysis. A mitigation management system oversees deployment of the mitigation workflow, tracks progress, and compares mitigation results and timing to a library of mitigation success metrics. The mitigation and completion management system updates the library of success metrics and reports on the threat mitigation responses to cybersecurity management. A machine learning model in the SOAR platform can analyze actions and responses generated by mitigation workflows and update the workflows in order to improve performance, based on the mitigation success metrics.

A network-connected security orchestration, automation, and response (SOAR) system is illustrated 500. The heart of a SOAR system can comprise a SOAR application or platform 510, where the SOAR platform can be based on one or more cybersecurity threat protection applications, tools, techniques, and so on. The SOAR platform can enable data collection from a wide range of data sources such as threat data sources. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. on a network-connected computer platform. The SOAR platform can provide threat alerts and can also provide contexts for the alerts. The SOAR platform can further automate responses to threats, adapt the responses using machine learning, and so on. The SOAR platform can use a library of cybersecurity mitigation success metrics to compare timing and effectiveness of mitigation steps to previous events and successful mitigation processes.

The illustration 500 can include one or more components associated with cybersecurity threat management. The SOAR platform can include a threat and vulnerability management component 512. The threat and vulnerability management component can configure and control IT infrastructure elements such as routers, switches, processors, storage area networks (SANs), and so on. The SOAR platform can include an incident response component 514. The incident response component can provide alerts, can trigger one or more actionable responses, and the like. In embodiments, the actionable response can enable scalability of a connected SOAR system. The SOAR system can be scaled up to address many threats, to reduce threat response time, etc. In embodiments, the actionable response can include a recommendation for cybersecurity operations staff. The recommendation can include a recommendation for a threat response policy, a source for further information about the threat, taking remedial steps, automating recidivistic actions, etc. In further embodiments, the actionable response can include an autonomic network reconfiguration. An autonomic network reconfiguration can include isolating IT elements, restricting IT elements, and the like. In embodiments, the actionable response can include an autonomic cybersecurity threat protection application reconfiguration. The threat protection application reconfiguration can include isolating, reinstalling, reconfiguring, or rebooting an application. The threat protection application reconfiguration can include synchronizing operation of two or more threat protection applications.

The illustration 500 can include security operations automation 516. Security operations management can include automatically securing IT infrastructure elements such as switches, routers, processors, storage elements, etc., where the securing can be based on a procedure, a policy, and so on. The security operations automation can include updating IT element software and firmware, installing, and configuring security software such as antivirus software, and the like. Cybersecurity threat application inputs can include alerts, text or SMS messages, email, a rendering on a graphical display, and so on. The analysis can be based on metadata associated with the plurality of inputs from the cybersecurity threat protection applications. The metadata can include a variety of status and other information such as a time and a frequency of cybersecurity threat protection application inputs, one or more techniques used to receive the application inputs, who or what tool provided the application inputs, etc. The mitigation response can include a workflow that can be developed to address, rectify, remediate, prevent, etc. the cybersecurity threat. The cybersecurity threat response can address various types of events such as a zero-day event.

The illustration 500 can include an artificial intelligence (AI) user interface (UI) 530. The Al user interface comprises a natural language processing (NLP) AI user interface. NLP uses rule-based and statistical models, as well as machine learning and deep learning techniques, to process and analyze large amounts of natural language data. In embodiments, the natural language AI user interface is embedded in the SOAR platform, wherein the natural language AI user interface is accessed by an application program interface (API) 532 in the SOAR platform. An application program interface (API) 532 is a set of programs and rules that allow different applications to exchange information. It acts as an intermediate layer that processes data between systems, allowing application data and functionality to extend to third-party developers as well as to internal departments within the same network. In embodiments, one or more APIs can be used to accept data from the one or more cybersecurity threat protection applications into the natural language AI user interface. The API can also be used to send requests for data and commands to the cybersecurity threat protection applications. The natural language AI user interface can be accessed using text and/or voice. The natural language AI user interface can be engaged by a cybersecurity network representative.

The illustration 500 includes one or more cybersecurity network compliance requirements 518. In embodiments, the compliance requirements 518 are based on one or more compliance standards, regulatory requirements, company policy documents, and company incident response documents. The compliance requirements can be based on company industry segment standards. Governments, businesses, industries, and regulatory bodies work to set and maintain cybersecurity standards for their members. Regulatory bodies routinely publish and update policies and standards as cybersecurity threats increase and evolve. Small businesses and private individuals can subscribe to cybersecurity services and purchase hardware and software that can help to mitigate the threats to their data, applications, and hardware, as well as their finances. Interpreting the network compliance requirements can be done by inputting text from regulatory and compliance documentation, internal company policy documents, audit findings, incident reports, and so on. The input can be done verbally or in written word through the AI user interface 530. Input from the cybersecurity threat protection applications can use the API 532 into the natural language AI user interface as well. The input from all of these sources into the database of the AI user interface can enable the SOAR platform to converse programmatically with the cybersecurity threat protection applications, interpret their data, respond to their input, and manage the tasks undertaken by the applications as they react to cybersecurity events. In embodiments, translating the network compliance requirements 518 into workflow policies 520 and processes that the threat protection applications can implement is performed using machine learning (ML) 534. The ML is embedded in the SOAR platform 510, wherein the ML is trained by data gathered by one or more instantiations of the SOAR platform. The ML can be accessed through an application program interface (API) in the SOAR platform. A machine learning (ML) model can be built using compliance and regulatory data from the natural language Al user interface and data from the cybersecurity threat protection applications input through one or more API.

The SOAR platform 510 can use a network 540 to access a plurality of cybersecurity threat protection applications 550. The network can include a wired network, a wireless network, a hybrid wireless/wireless network, and so on. The network can be based on wired networking standards such as Ethernet™ (IEEE 802.3), wireless networking standards such as Wi-Fi™ (IEEE 802.11), and so on. The cybersecurity threat protection applications can provide capabilities such as endpoint protection, anti-phishing, antivirus, firewalls, and so on. The cybersecurity threat protection applications can further detect and protect against man-in-the middle ruses, denial-of-service (DOS) and distributed denial-of-service (DDOS) attacks, ransomware, and the like. In embodiments, the background synchronization service can communicate to the plurality of network-connected cybersecurity threat protection applications using cloud services 560. The cloud services can provide access and can also provide IT services such as software as a service (SaaS), platform as a service (PaaS), infrastructure as a service (IaaS), and so on.

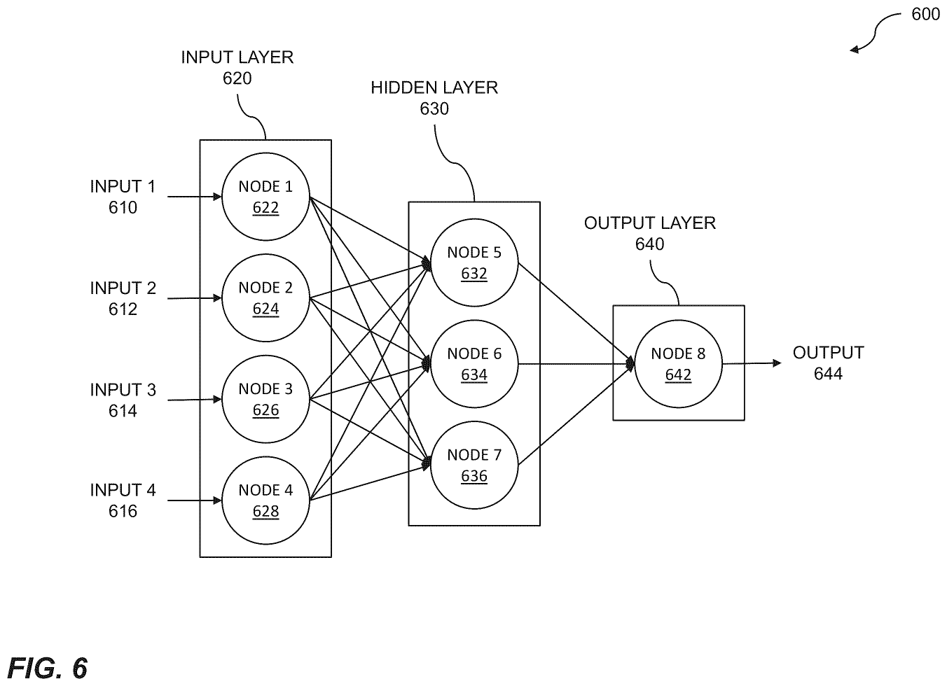

FIG. 6 shows an example neural network 600 for machine learning. The neural network for machine learning can be based on a variety of neural network types such as a convolutional neural network (CNN), a deep neural network (DNN), a recurrent neural network (RNN), and so on. The neural network for machine learning comprises a plurality of layers, where the layers can include one or more of an input layer, an output layer, a convolutional layer, a bottleneck layer, an activation layer, and the like. The bottleneck layer, if present within the neural network, can be used for neural network training. The trained neural network can be applied to cybersecurity operations tasks such as cybersecurity operations case triage groupings. A neural network for machine learning can apply classifiers. The classifiers can be learned based on one or more inputs from a plurality of network-connected cybersecurity threat protection applications. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. The inputs are triaged into groupings, based on the metadata. A cybersecurity threat response is generated, based on the groupings.

The example 600 shows a neural network for machine learning. The neural network includes one or more layers such as input layers, hidden layers, and output layers. Layers, such as convolutional layers, activation layers, bottleneck layers, etc., that perform operations associated with applications such as machine learning can also be included within the example neural network. Data can be provided to the neural network though inputs such as input 1 610, input 2 612, input 3 614, and input 4 616. While four inputs are shown, other numbers of inputs can also be applied to the neural network. The data can include training data, production data, etc. The data is provided to an input layer 620 of the neural network. The input layer comprises one or more nodes such as node 1 622, node 2 624, node 3 626, and node 4 628. While four nodes are shown within the input layer, other numbers of nodes can be included. One or more weights (explained below) can also be provided to each node within the input layer. The outputs of the nodes associated with the input layer can be coupled to inputs of nodes associated with a hidden layer such as hidden layer 630. The hidden layer can comprise one or more nodes such as node 5 632, node 6 634, and node 7 636. While three nodes are shown, other numbers of nodes can be included in the hidden layer. In the example neural network, each output of the nodes associated with the input layer is coupled to each input of the nodes associated with the hidden layer. The coupling of each node output to each node input accomplishes a fully connected (FC) layer within the neural network.

The example neural network can include one or more hidden layers. The hidden layers can include substantially similar or substantially dissimilar numbers of nodes. The hidden layers can be fully connected layers as just described, convolutional layers where a subset of outputs is connected to a subset of inputs, bottleneck layers, activation layers, etc. The example neural network includes an output layer 640. The output layer can include one or more nodes such as node 8 642. While one node is shown within the output layer, the output layer can include more than one node. The output layer produces an output 644. The output can include a value, a probability, and so on.

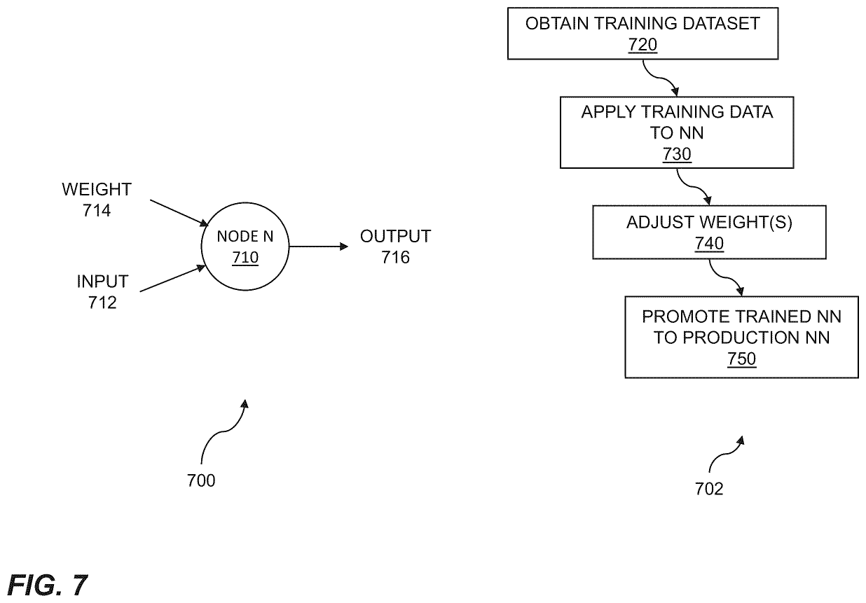

FIG. 7 shows an example 700 of training a neural network for machine learning. As discussed in FIG. 6, a neural network comprises layers of nodes or neurons such as artificial neurons 622, 632, and 642, among others. The artificial neuron can be configured to process input data in order to produce output data. An example node N 710 is shown. A neuron can be coupled to one or more signals or inputs such as input 712, and one or more weights such as weight 714. The node multiplies each input by its corresponding weight and maintains a running sum of the resulting products. The output of the node, such as output 716, can be calculated by applying a function such as a transfer function to the sum of products of the inputs and weights. The transfer function can include various types of functions such as a unit step or threshold function, a sigmoid, a Gaussian function, a piece-wise linear function, and so on.

Each neuron within a neural network can be trained. The training can be based on using a dataset that includes known data. The training can be further based on comparing results of data processing by the neural network with expected results associated with the known data. The expected results include results of neural network processing of the dataset of known data. One or more weights associated with each node are adjusted until the neural network can form an inference that produces the expected result. In a usage example, a dataset of images of dogs or cats can be used to train a neural network to identify dogs or cats within images not included in the training data set. A flow for neural network training is shown. The neural network training can include training a neural network for machine learning applications. The flow 702 includes obtaining 720 a training dataset. The training dataset can include cybersecurity operations center caseload histories, resolutions to cybersecurity threats, and so on. The training dataset can include threat response resolution metrics. The training dataset can further include one or more objective ratings, where the objective ratings can be used to update the threat response resolution metrics. Further, a subjective rating can include a management-supplied rating, a peer-supplied rating, a machine-learning-supplied rating, etc.

The flow 702 includes applying 730 the training data to a neural network. The training data is provided to the inputs of the neural network and the neural network proceeds to process the test data. The flow 702 includes adjusting one or more weights 740 associated with the nodes of the neural network. The adjusting the weights can enable enhanced convergence by the neural network to an expected result. The enhanced convergence can reduce neural network processing time, improve inference accuracy, etc. The adjusting the weights can include an iterative process. The adjusting weights associated with the nodes within the neural network can become more accurate as further training data is provided. The flow 702 includes promoting the trained neural network 750 to a production neural network. The production neural network can be used to process data such as a security operations center (SOC) caseload history. The production neural network can continue to adapt or learn based on processing further data. The learning can include further adjustment to one or more weights associated with nodes within the neural network. In embodiments, the accessing, the analyzing, the augmenting, the receiving, and the assigning, all of which are discussed previously, can be converted to machine learning training data. The machine learning training data that was converted can be used to further train or adjust the machine learning neural network.

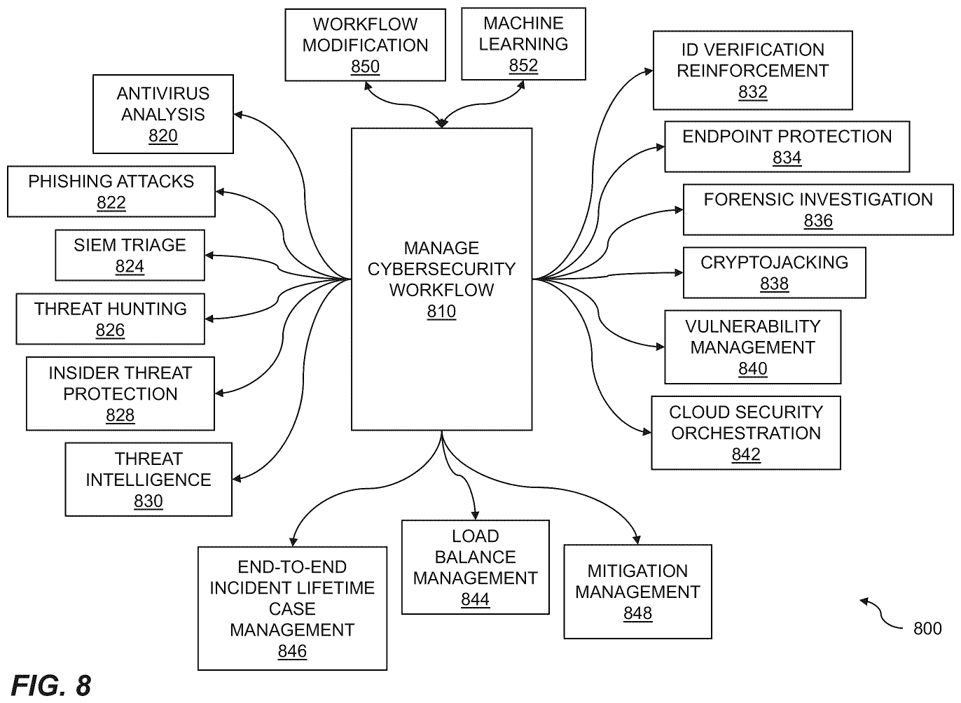

FIG. 8 is an infographic for cybersecurity workflow management. Information technology (IT) infrastructure comprises computing devices, storage devices, networks, perhaps personal devices, operating systems, cloud-based systems, and so on. Whether these IT elements are operated by an individual for personal use or by an organization in support of operations, all of the IT elements are nearly constant targets of malicious attacks from outside an organization. Worse yet, some of the attacks originate from within an organization. A plurality of network-connected cybersecurity threat protection applications is accessed. A plurality of cybersecurity network compliance requirements is also accessed. The cybersecurity network compliance requirements are translated into cybersecurity threat protection application policies and workflows used to direct the cybersecurity threat protection applications as they respond to cybersecurity events. A plurality of inputs is received from the cybersecurity threat protection applications, wherein the plurality of inputs is initiated by one or more cybersecurity events. A computer platform is used to analyze the plurality of inputs from the cybersecurity threat protection applications. The inputs are analyzed by a threat and mitigation management system. A cybersecurity threat mitigation response is generated, deployed, tracked, and compared to cybersecurity network compliance requirements. The completion of mitigation events is stored and reported to cybersecurity administrators and managers. The actions and responses generated by cybersecurity workflows are analyzed by machine learning and modified to improve performance and compliance with requirements.

The infographic 800 includes cybersecurity management 810. Cybersecurity management can include prioritizing a variety of IT techniques for identifying threat risks, correcting identified risks, counteracting active threats, and so on. Cybersecurity management can be based on accessing a range of applications (discussed below) which can include antivirus software, access control, data encryption, network channel encryption, and the like. In embodiments, cybersecurity includes managing the plurality of threat protection applications for a data network. The techniques that can be used for cybersecurity management can be based on one or more workflows. The workflows, which can include cybersecurity tasks and commands, can automate various tasks associated with cybersecurity management. In embodiments, the managing cybersecurity can include graphical control of the plurality of cybersecurity threat protection applications. The graphical control can enable dragging and dropping of tasks, commands, and so on into a workflow. In other embodiments, the automation workflows can support dynamic swapping of cybersecurity threat protection applications. The workflows can support swapping-in or swapping-out one or more threat protection applications. The swapping-in and the swapping-out are enabled by a universal data layer (UDL). The UDL enables applications to be swapped without having to edit a workflow or create a new workflow to address the swapped-in application.

The infographic 800 can include workflow modification 850. In embodiments, actions and responses generated by cybersecurity threat management applications, security operations staff, users, third-party AI systems, the SOAR platform, and so on can be captured as cybersecurity incidents occur. The cybersecurity workflows, actions, responses, and timings can be analyzed by machine learning 852 and the results compared to established requirements. The analysis can include responses generated by threat protection applications, separate Al security systems, or security operations staff. The analysis can include remedial step actions suggested to security operations staff by the SOAR platform or cybersecurity threat protection applications. The analysis can include recidivistic security operations responses generated by threat protection applications or operations staff members. The analysis can include repeated cybersecurity incidents logged by the SOAR platform or the security operations center. The analysis can include cybersecurity operations regression exercises. The machine learning analysis can use multiple instantiations of the SOAR platform to generate and test changes to the order of workflow steps, automation of recidivistic responses, changes in schedule or timing of actions, and so on. The machine learning 852 can generate updates to the workflows automatically in real time, including remedial steps or the reordering of remedial steps.

An Al user interface included in the SOAR platform can be used to assimilate cybersecurity network compliance requirements. The compliance requirements are based on one or more compliance standards, regulatory requirements, company policy documents, and company incident response documents. The infographic 800 includes translating the cybersecurity network compliance requirements into one or more cybersecurity application policies. The cybersecurity application policies provide cybersecurity network conformity with the compliance requirements. Input from the various compliance, regulatory, and company policy statements regarding cybersecurity standards and responses into a natural language AI user interface allows the SOAR platform to interpret the requirements for the threat protection applications installed on the managed cybersecurity network. Input from the cybersecurity threat protection applications allows the SOAR platform to interact with the applications. In embodiments, translating the network compliance requirements into policies and workflows that the threat protection applications can implement is performed using machine learning (ML) 852. The ML 852 is embedded in the SOAR platform, wherein the ML is trained by data gathered by one or more instantiations of the SOAR platform. The ML can be accessed through an application program interface (API) in the SOAR platform. A machine learning (ML) model can be built using compliance and regulatory data from the natural language AI user interface and data from the cybersecurity threat protection applications input through one or more APIs. In embodiments, the result is to generate a set of application policies and workflows for each of the cybersecurity threat protection applications that direct the applications to respond to cybersecurity events in a manner that is consistent with the internal and external regulatory and compliance requirements for the network. The cybersecurity application policies and workflows can include information on how to respond to specific types of threats, how often to report operational status, how often and when to install updates, whom to notify during priority events, how to notify, and so on. The cybersecurity application policies and workflows can include details on which processes are to be handled by the SOAR platform, so that only condition and status data is sent forward to the SOAR platform, and which processes are to be handled by the threat protection applications directly, with status data to follow. The policies and workflows can include settings on how a threat protection application is to proceed in the event the SOAR platform is unavailable, and so on.

The infographic 800 includes antivirus analysis 820. Antivirus analysis can include virus detection, Trojan horse program detection, and so on. The analysis can include determining a source or vector of a virus, the actions taken by the virus, how to counter actions taken by the virus, to whom the virus might be in communication, etc. The antivirus analysis can be used to determine changes or updates to the virus, and how to better detect the virus before it can be deployed. The infographic 800 can include analysis of phishing attacks 822. Phishing is a form of attack that attempts to fraudulently obtain personal, sensitive, or private data and information. The data or information that is sought by a phishing attack can include personal information such as name, address, date of birth, telephone number, email address, and so on. The information can further include government-related information such as social security numbers, tax records, military service information, etc. The information can also include usernames and passwords to sensitive websites such as banks, brokerages, hospitals and health care providers, and the like. A phishing attack can purport to be from an entity known to a user by presenting the user with a legitimate looking webpage. However, links on the fraudulent page do not take the user to the legitimate site, but rather to a site designed to steal the victim's data.

The infographic 800 includes security information and event management (SIEM) triage 824. SIEM, which combines the management of security information and security events, can provide analysis of security alerts, alarms, warnings, etc. in real time. The alerts that are analyzed can be generated by one or more of the plurality of cybersecurity threat protection applications, by network security hardware, and so on. The triage can be used to determine the severity of an alert, the scale or extent of the alert, the urgency of the alert, and the like. The infographic 800 includes threat hunting 826. Threat hunting can include techniques used to locate cybersecurity threats within a network, where the threats can elude detection using more common threat detection techniques. Threat hunting can include iteratively searching network-connected devices throughout a data network. Threat hunting can be used in addition to common cybersecurity techniques including firewalls for port blocking, intrusion detection, etc. The infographic 800 includes insider threat protection 828. Insider threats are among the most difficult threats to counter because they are perpetrated by people who have knowledge of the security techniques implemented by an organization. An insider threat attack can include physical damage to computing, data, and network systems; data breaches; and the like. Insider threats can result from overly permissive access to sensitive areas or data, lax firewall policies, etc. An insider attack can include moving sensitive data to another device within the organization-a lateral transfer.

The infographic 800 includes threat intelligence 830. Threat intelligence can include information associated with cybersecurity threats, used by an organization. The threat intelligence information can be associated with past security threats, current security threats, and threats likely to arise in the future. The information can be used by the organization to identify cybersecurity threats, to prevent the threats, and to prepare for inevitable threats that are likely to emerge in the future. The infographic 800 includes identity verification reinforcement 832. Identity verification can include techniques to verify that a person who has access to computing systems, data systems, networks, and so on that are associated with an enterprise, is in fact a real person. Identity verification can be based on physical documents such as a government issued identification documents. The infographic 800 can include endpoint protection 834. In a typical enterprise computing environment, individuals may try to use personal electronic devices to access the enterprise network. Such devices can include laptop computers, tablets, PDAs, smartphones, and the like. Such devices can pose a serious threat to an enterprise network because of operating systems which may not be updated, questionable applications which may be installed on the devices, etc. Endpoint protection can require that any device, including personal electronic devices, meets certain standards prior to connection to the enterprise network. The standards can include approved devices, operating systems, applications, antivirus applications, virtual private network apps, etc.

The infographic 800 includes forensic investigation 836. Digital forensic investigation can include data recovery, data maintenance, and investigation of data and information that can be found on various digital devices. Digital forensic techniques can be applied for investigation of a variety of digital malfeasances including cybercrime. Forensic investigation techniques can be used to determine, track, and locate perpetrators of cybercrime. The infographic 800 includes the detection of cryptojacking 838. Cryptojacking can include hijacking of computers, servers, personal electronic devices, and so on for the purposes of mining cryptocurrency. The infographic 800 includes vulnerability management 840. Vulnerability management seeks to reduce risks to computing systems, data systems, networks, and so on by identifying, evaluating, correcting, and communicating vulnerabilities associated with the computing systems and the applications that are executed on the computing systems. The infographic 800 includes cloud security orchestration 842. Many individuals, and organizations such as businesses, hospitals, universities, and government agencies, use cloud services for processing, data storage, and other IT services. Cloud orchestration can manage relationships, interactions, and communications among computational workloads. The computational workloads can be associated with public cloud infrastructure and private cloud infrastructure. Cloud security orchestration can include imposing permissions and access oversight, and policy enforcement.

The infographic 800 includes load balance management 844. The load balance management can balance and adjust assignment of cybersecurity threats to one or more analysts. The load balance management attempts to assign a cybersecurity threat to a specific analyst who is best suited to handling and addressing the cybersecurity threat. If the caseload associated with the analyst is “heavy” or “full”, then one or more cases assigned to that analyst can be reassigned to one or more other analysts. In embodiments, the reassigning can include a re-triage of an existing SOC caseload. The re-triage results can be used to reassign one or more analysts determined to be capable of handling the cybersecurity threat. The infographic 800 includes end-to-end incident lifetime case management 846. An incident can include a virus outbreak, a distributed denial-of-service (DDOS) attack, and the like. Incident lifetime management can include identifying that an incident has occurred, notifying that the incident has occurred and escalating response to the incident, investigating and diagnosing the incident, resolving the incident, and recovering from the incident. Incident lifetime management can further include closing the incident. The infographic 800 includes mitigation management 848. The mitigation management can coordinate actions taken by cybersecurity threat protection applications and security analysts as they are implemented. The timing and effectiveness of the mitigation steps can be tracked and compared to a library of cybersecurity mitigation success metrics. The results can be reported to cybersecurity managers and machine learning models to improve responses and identify possible weak points in network security.

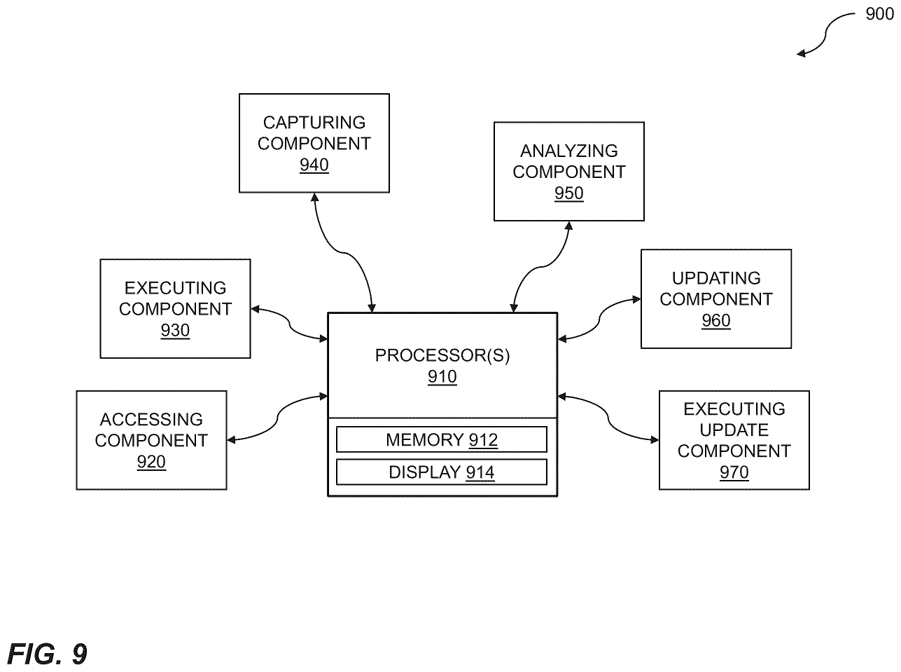

FIG. 9 is a system diagram for cybersecurity AI-driven workflow modification. The system 900 can include one or more processors 910 attached to a memory 912 which stores instructions. The system 900 can include a display 914 coupled to the one or more processors 910 for displaying data, video streams, videos, intermediate steps, instructions, and so on. In embodiments, one or more processors 910 are coupled to the memory 912 where the one or more processors, when executing the instructions which are stored, are configured to: access a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform; execute a cybersecurity workflow, using the SOAR platform; capture one or more cybersecurity actions, wherein the one or more cybersecurity actions are related to execution of the cybersecurity workflow; analyze the one or more cybersecurity actions for workflow relevance; and update the cybersecurity workflow on the SOAR platform, based on the analyzing.

The system 900 includes an accessing component 920. The accessing component 920 can include functions and instructions for accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform. Threat protection applications can monitor, protect, and defend computer systems, data systems, data networks, handheld electronic devices, and so on against various types of malicious attacks. The threat protection applications can include antivirus and anti-phishing applications, tools for threat hunting and threat intelligence, identity verification, endpoint protection, and so on. The threat applications can further include firewalls and other blocking technology. The threat protection applications can be installed on the various network-based IT components to counter the increasing variety of malicious cyberattacks. The threat protection applications can include antivirus, anti-phishing, and anti-cryptojacking applications; tools for threat hunting and threat intelligence; identity verification; endpoint protection; forensic investigation; incident management; and so on. The SOAR platform can enable data collection from a wide range of data sources such as threat data sources using an artificial intelligence (AI) user interface. The threat data sources can include data uploaded by cybersecurity experts, data produced by cybersecurity threat protection applications, and so on. The SOAR platform can be used to manage threat protection processes, anti-threat technologies, and human expertise. The SOAR platform can centralize management of IT assets such as networks, processors, data storage elements, etc. The SOAR platform can provide threat alerts and can also provide contexts for the alerts. The SOAR platform can further automate responses to threats, adapt the responses using machine learning, and so on.

The system 900 includes an executing component 930. The executing component 930 can include functions and instructions for executing a cybersecurity workflow, using the SOAR platform. In embodiments, the cybersecurity workflow can include managing one or more, two or more, three or more, four or more, five or more, or any other combination of: antivirus analysis, malware attacks, worms, trojans, spyware, browser hijacking, search hijacking, rootkits, ransomware, phishing attacks, security information and event management triage, threat hunting, insider threat protection, threat intelligence, identity verification reinforcement, endpoint protection, forensic investigation, cryptojacking, vulnerability management, cloud security orchestration, and end-to-end incident lifecycle case management. The cybersecurity workflow can include non-cybersecurity elements. As cybersecurity events occur, the cybersecurity threat protection applications log events and report statuses and actions taken to the SOAR platform. The SOAR platform responds with additional requests, commands, communications, and so on as the event progresses. Reporting to incident lifecycle applications, updating security personnel, receiving updates from vendors, modifying application behaviors, and so on can all be a part of the cybersecurity incident. In embodiments, a cybersecurity workflow can include one or more threat protection application actions and responses, as well as interactions with security staff, and artificial intelligence (AI) machine learning model actions and responses.

The system 900 includes a capturing component 940. The capturing component 940 can include functions and instructions for capturing one or more cybersecurity actions, wherein the one or more cybersecurity actions are related to execution of the cybersecurity workflow. In embodiments, the one or more cybersecurity actions can be implemented in response to an element of the cybersecurity workflow being executed. The cybersecurity workflow element can include actions initiated by personnel staffing a security operations center. The cybersecurity workflow element can include actions initiated by a separate AI system, wherein the separate AI system is distinct from the SOAR. In embodiments, the one or more cybersecurity actions can be implemented in response to an input from the plurality of threat protection applications. As the cybersecurity workflow proceeds, log entries, reports, and discreet responses from the SOAR platform, threat protection applications, third-party applications, workstations, network devices, security staff, and so on can be captured and forwarded to an AI machine learning model.

The system 900 includes an analyzing component 950. The analyzing component 950 can include functions and instructions for analyzing the one or more cybersecurity actions for workflow relevance. In embodiments, the analyzing can be performed using machine learning, wherein the machine learning is embedded in the SOAR platform. The machine learning can be trained by data gathered by one or more instantiations of the SOAR platform. The machine learning can be accessed through an application program interface (API) in the SOAR platform. A machine learning (ML) model can be built using data from a natural language AI user interface and data from the cybersecurity threat protection applications through one or more APIs. Previous cybersecurity events occurring on the network and captured by the SOAR platform can be used as training data. Multiple instantiations of the SOAR platform can be generated to test and refine actions and responses to various cybersecurity threats, application update requirements, actions taken by users and/or operations security staff members, and so on.

The workflow relevance can include identifying a recidivistic security operations center human response to the one or more cybersecurity actions. The recidivistic human response can be received from personnel staffing a security operations center. In embodiments, some cybersecurity workflows can be executed repeatedly. Updates to cybersecurity applications, firmware, and hardware, scheduled virus scans, installations of security software onto new workstations, reviewing relevant regulatory or policy statements from internal and external sources, and so on, can be executed multiple times each week or month. In many cases, the responses to the SOAR platform generated by human cybersecurity operations staff can be the same each time a particular workflow is executed. Over time, as cybersecurity workflows are executed and recidivistic responses from users or security operations staff are recorded, the AI machine learning model can identify the routine human replies and make updates to the workflow that can mimic the human responses.

The analyzing component 950 can include functions and instructions for evaluation of workflow quality. In embodiments, the evaluation of workflow quality can be based on repeated incidents logged by the security operations center. The evaluation of workflow quality can be based on operation regression exercises related to the security operations center. In some embodiments, the analyzing can trigger a remedial step action suggestion to personnel staffing a security operations center. The result is that as more executions of cybersecurity workflows are completed and analyzed by the SOAR platform using the embedded AI machine learning model, the more efficient and effective the workflows can become. Cybersecurity operations staff can learn from regression exercises, multiple instantiations of the SOAR platform can be employed to test workflow options and train the machine learning model, input from third-party security platforms can be ingested, regulatory and compliance data can be analyzed, and so on, to continually refine and improve workflows as they are used to protect and defend digital networks from both internal and external threats.

The system 900 includes an updating component 960. The updating component 960 can include functions and instructions for updating the cybersecurity workflow on the SOAR platform, based on the analyzing. In embodiments, the updating can mimic one or more recidivistic human responses. The updating can occur in real time. The updating can enable parallel remedial step execution in the cybersecurity workflow that was updated. The updating can cause a reordering of existing remedial steps. The goal of updating the cybersecurity workflow is to improve the efficiency and effectiveness of the actions taken by threat protection applications, third-party applications, security operations staff, and users, thereby increasing productivity and preventing data loss. The AI machine learning model can execute multiple instantiations of the SOAR platform in order to test multiple iterations of workflows, comparing and contrasting response times and effectiveness, identifying delays due to security operations staff, third-party applications, network downtime, maintenance windows, and so on. The machine learning model can vary the order of steps in the workflow, measure time saved by automating human security staff responses, identify actions by staff members, applications, or the SOAR platform that resulted in remedial steps being taken at a later time, and so on. The machine learning model can recommend that the human response by the operations staff be replaced with an automated response in the affirmative. In some embodiments, a notification to the security operations staff can be added to the workflow, including an option to deny the installation of the update or reschedule it. Allowing the update to be uploaded immediately to those workstations that are connected to the network can improve efficiency and reduce the risk of virus infection. In some embodiments, the SOAR platform can be managed so that workflow updates are implemented in real time, with a follow-up notification to the security operations staff. This can be especially useful when cybersecurity attacks occur during off-hours, long weekends, etc. The network operations security staff can decide which workflows can be updated automatically and which must be approved prior to change.

The system 900 includes an executing update component 970. The executing update component 970 can include functions and instructions for executing the cybersecurity workflow that was updated on the SOAR platform. In embodiments, the SOAR platform can be used to execute updated workflows using new cybersecurity events, operations regression test variables, previous incidents, scenarios supplied by third-parties, interactions with security operations staff, and so on. The machine learning model can compare the updated workflow efficiency and effectiveness to the previous version of the workflow, as well as alternate versions supplied by external or internal sources. In some instances, the SOAR platform can execute the updated workflow using a routine schedule previously established for the workflow. In some embodiments, a comparison report showing the updated workflow alongside the previous version can be generated, including times, responses, and calculated changes in efficiency.

The system 900 can include a computer program product embodied in a non-transitory computer readable medium for cybersecurity management, the computer program product comprising code which causes one or more processors to perform operations of: accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform; executing a cybersecurity workflow, using the SOAR platform; capturing one or more cybersecurity actions, wherein the one or more cybersecurity actions are related to execution of the cybersecurity workflow; analyzing the one or more cybersecurity actions for workflow relevance; and updating the cybersecurity workflow on the SOAR platform, based on the analyzing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for cybersecurity management comprising:
accessing a plurality of cybersecurity threat protection applications, wherein the plurality of cybersecurity threat protection applications is deployed across a managed cybersecurity network, and wherein the plurality of cybersecurity threat protection applications is managed using a security orchestration, automation, and response (SOAR) platform;
executing a cybersecurity workflow, using the SOAR platform, wherein the cybersecurity workflow includes instructions to manage three or more of: antivirus analysis, malware attacks, worms, trojans, spyware, browser hijacking, search hijacking, rootkits, ransomware, phishing attacks, security information and event management triage, threat hunting, insider threat protection, threat intelligence, identity verification reinforcement, endpoint protection, forensic investigation, cryptojacking, vulnerability management, cloud security orchestration, and end-to-end incident lifecycle case management;
capturing data representing one or more cybersecurity actions that are performed in response to execution of the cybersecurity workflow, wherein the captured data comprise reports generated by the SOAR platform, the plurality of cybersecurity threat protection applications, and network devices;
analyzing the one or more cybersecurity actions for workflow relevance based on providing the one or more cybersecurity actions as input to an artificial intelligence (AI) machine learning model, wherein:
the AI machine learning model was trained to (i) analyze the one or more cybersecurity actions and timings of automated responses in the cybersecurity workflow and (ii) compare the analysis to historic cybersecurity actions and timings of automated responses,
the AI machine learning model was trained using (i) data from a natural language AI user interface and data, (ii) data from the plurality of cybersecurity threat protection applications, and (iii) historic cybersecurity events data captured by the SOAR platform, and
the analyzing further comprises:
generating multiple versions of the SOAR platform using the AI machine learning model, wherein the multiple versions of the SOAR platform comprise alternative workflows, reordering of steps in the alternative workflows, added tasks in the alternative workflows, and parallel remedial steps in the alternative workflows;
executing each of the multiple versions of the SOAR platform to test potential actions and responses to different cybersecurity threats and application update requirements; and
determining, based on executing the multiple versions of the SOAR platform, respective workflow relevance;
automatically updating, in real-time, the cybersecurity workflow on the SOAR platform based on the analyzing, wherein updating the cybersecurity workflow comprises reordering existing remedial steps in the cybersecurity workflow that are performed by an AI computer system to improve efficiency and effectiveness of the one or more cybersecurity actions; and
executing, in parallel to updating the cybersecurity workflow and in real-time, one or more of the remedial steps of the updated cybersecurity workflow, wherein executing the one or more of the remedial steps causes the AI computer system to automatically perform the one or more of the remedial steps.

2. The method of claim 1 further comprising automatically executing the updated cybersecurity workflow on the SOAR platform.

3. The method of claim 1 wherein the one or more cybersecurity actions are implemented in response to an element of the cybersecurity workflow being executed.

4. The method of claim 3 wherein the element includes an action initiated by personnel staffing a security operations center.

5. The method of claim 3 wherein the element includes an action initiated by a separate AI system.

6. The method of claim 5 wherein the separate AI system is distinct from the SOAR platform.

7. The method of claim 1 wherein the one or more cybersecurity actions are implemented in response to an input from the plurality of cybersecurity threat protection applications.

8. The method of claim 7 wherein in response to the analyzing, the method further comprises automatically triggering a remedial step action suggestion to be performed by personnel staffing a security operations center, wherein the remedial step action suggestion is provided to and displayed at a computing device of the personnel.

9. The method of claim 1 wherein the workflow relevance includes identifying a recidivistic security operations center human response to the one or more cybersecurity actions.

10. The method of claim 9 wherein the recidivistic security operations center human response is received as input from a computing device of personnel staffing a security operations center.

11. The method of claim 9 wherein automatically updating the cybersecurity workflow comprises updating the cybersecurity workflow to mimic the recidivistic security operations center human response.

12. The method of claim 1 wherein the automatically updating occurs in real time.

13. The method of claim 1 wherein the automatically updating enables parallel remedial step execution in the cybersecurity workflow that was updated automatically.

14. The method of claim 1 wherein the automatically updating causes a reordering of existing remedial steps in the cybersecurity workflow.

15. The method of claim 1 wherein the analyzing comprises evaluation of workflow quality.

16. The method of claim 15 wherein the evaluation of workflow quality is based on analysis of repeated incidents having been logged by a security operations center.

17. The method of claim 15 wherein the evaluation of workflow quality is based on analysis of operation regression exercises related to a security operations center.

18. The method of claim 1 wherein the AI machine learning model is embedded in the SOAR platform and trained using data gathered by one or more instantiations of the SOAR platform.

19. The method of claim 1 wherein the AI machine learning model is accessed through an application program interface in the SOAR platform.

20. The method of claim 1 wherein the cybersecurity workflow further comprises non-cybersecurity elements.
